(19) United States
(12) Patent Application Publication
(10) Pub. No.: US 2025/0280108 A1
(43) Pub. Date: Sep. 4, 2025

(54) ENCODING METHOD, DECODING METHOD, CODE STREAM, ENCODERS, DECODERS, AND STORAGE MEDIUM

(71) Applicant: GUANGDONG OPPO MOBILE TELECOMMUNICATIONS CORP., LTD., Dongguan (CN)

(72) Inventors: Junyan HUO, Dongguan (CN); Yanzhuo MA, Dongguan (CN); Fuzheng YANG, Dongguan (CN); Zhenyao ZHANG, Dongguan (CN); Ming LI, Dongguan (CN)

(73) Assignee: GUANGDONG OPPO MOBILE TELECOMMUNICATIONS CORP., LTD., Dongguan (CN)

(21) Appl. No.: 19/199,870

(22) Filed: May 6, 2025

Related U.S. Application Data
(63) Continuation of application No. PCT/CN2022/130727, filed on Nov. 8, 2022.

(51) Int. Cl. H04N 19/105; H04N 19/176; H04N 19/186

(52) U.S. Cl. CPC H04N 19/105; H04N 19/176; H04N 19/186

(57) ABSTRACT

Disclosed in the embodiments of the present application are an encoding method, a decoding method, a code stream, encoders, decoders, and a storage medium. The decoding method comprises: determining a reference block of the current block, wherein the reference block is a neighboring block of the current block; when a prediction mode of a second color component of the reference block meets a first condition, determining a reference intra-frame prediction mode parameter based on the reference block; and determining a predicted value of a second color component of the current block according to the reference intra-frame prediction mode parameter.

### CROSS-REFERENCE TO RELATED APPLICATIONS

This application is a continuation of International Application No. PCT/CN2022/130727, filed on Nov. 8, 2022, the disclosure of which is hereby incorporated by reference in its entirety.

### TECHNICAL FIELD

Embodiments of this application relate to the field of video encoding/decoding technologies, and in particular, to encoding and decoding methods, a bitstream, an encoder, a decoder, and a storage medium.

### BACKGROUND

With an increasing demand of people for video display quality, new video application forms such as high-definition and ultra-high-definition videos have emerged. The Joint Video Exploration Team (JVET) formed by the International Organization for Standardization ISO/IEC and the ITU-T developed the video coding standard H.266/versatile video coding (VVC).

In H.266/VVC, a cross-component prediction technology mainly includes a cross-component linear model (CCLM) mode. However, for a mode other than the CCLM mode (that is, non-CCLM mode), a constructed candidate list is incomplete, resulting in poor chroma intra prediction and reduced encoding and decoding efficiency.

### SUMMARY

Embodiments of this application provide encoding and decoding methods, a bitstream, an encoder, a decoder, and a storage medium, which not only can improve accuracy of chroma intra prediction, but also can improve encoding and decoding efficiency, thereby improving encoding and decoding performance.

Technical solutions in embodiments of this application may be implemented as follows.

According to a first aspect, an embodiment of this application provides a decoding method, including:
determining a reference block of a current block, where the reference block is an adjacent block of the current block;
when a prediction mode of a second color component of the reference block satisfies a first condition, determining a reference intra prediction mode parameter based on the reference block; and
determining a predicted value of a second color component of the current block based on the reference intra prediction mode parameter.

According to a second aspect, an embodiment of this application provides an encoding method, including:
determining a reference block of a current block, where the reference block is an adjacent block of the current block;
when a prediction mode of a second color component of the reference block satisfies a first condition, determining a reference intra prediction mode parameter based on the reference block;
determining a predicted value of a second color component of the current block based on the reference intra prediction mode parameter; and
determining a predicted difference value of the second color component of the current block based on the predicted value of the second color component of the current block.

According to a third aspect, an embodiment of this application provides a bitstream. The bitstream is generated by performing bit encoding on to-be-encoded information, and the to-be-encoded information includes at least one of the following:
a predicted difference value of a second color component of a current block, a mode index number, or a first parameter.

According to a fourth aspect, an embodiment of this application provides an encoder, including a first determining unit and a first prediction unit.

The first determining unit is configured to: determine a reference block of a current block, where the reference block is an adjacent block of the current block; and when a prediction mode of a second color component of the reference block satisfies a first condition, determine a reference intra prediction mode parameter based on the reference block.

The first prediction unit is configured to determine a predicted value of a second color component of the current block based on the reference intra prediction mode parameter.

The first determining unit is further configured to determine a predicted difference value of the second color component of the current block based on the predicted value of the second color component of the current block.

According to a fifth aspect, an embodiment of this application provides an encoder, including a first memory and a first processor.

The first memory is configured to store a computer program runnable on the first processor.

The first processor is configured to run the computer program to execute the method according to the second aspect.

According to a sixth aspect, an embodiment of this application provides a decoder, including a second determining unit and a second prediction unit.

The second determining unit is configured to: determine a reference block of a current block, where the reference block is an adjacent block of the current block; and when a prediction mode of a second color component of the reference block satisfies a first condition, determine a reference intra prediction mode parameter based on the reference block.

The second prediction unit is configured to determine a predicted value of a second color component of the current block based on the reference intra prediction mode parameter.

According to a seventh aspect, an embodiment of this application provides a decoder, including a second memory and a second processor.

The second memory is configured to store a computer program runnable on the second processor.

The second processor is configured to run the computer program to execute the method according to the first aspect.

According to an eighth aspect, an embodiment of this application provides a computer-readable storage medium, where the computer-readable storage medium stores a computer program, and the computer program is executed to implement the method according to the first aspect or the method according to the second aspect.

Embodiments of this application provide encoding and decoding methods, a bitstream, an encoder, a decoder, and a storage medium. Regardless of an encoding side or a decoding side, a reference block of a current block is determined, where the reference block is an adjacent block of the current block; when a prediction mode of a second color component of the reference block satisfies a first condition, a reference intra prediction mode parameter is determined based on the reference block; and a predicted value of a second color component of the current block is determined based on the reference intra prediction mode parameter.

### BRIEF DESCRIPTION OF DRAWINGS

FIG. 1 is a schematic diagram of a position relationship between a luma CU and a chroma CU according to an embodiment of this application.

FIG. 2 is a schematic diagram of another position relationship between a luma CU and a chroma CU according to an embodiment of this application.

FIG. 3 is a schematic diagram of still another position relationship between a luma CU and a chroma CU according to an embodiment of this application.

FIG. 4 is a schematic diagram of still another position relationship between a luma CU and a chroma CU according to an embodiment of this application.

FIG. 5 is a schematic diagram of position distribution of reference chroma samples adjacent to a current block according to an embodiment of this application.

FIG. 6 is a schematic block diagram of composition of an encoder according to an embodiment of this application.

FIG. 7 is a schematic block diagram of composition of a decoder according to an embodiment of this application.

FIG. 8 is a schematic diagram of a network architecture of a codec system according to an embodiment of this application.

FIG. 9 is a schematic flowchart 1 of a decoding method according to an embodiment of this application.

FIG. 10A is a schematic diagram 1 of a position distribution of reference chroma samples according to an embodiment of this application.

FIG. 10B is a schematic diagram 1 of a position distribution of reference luma samples according to an embodiment of this application.

FIG. 11A is a schematic diagram 2 of a position distribution of reference chroma samples according to an embodiment of this application.

FIG. 11B is a schematic diagram 2 of a position distribution of reference luma samples according to an embodiment of this application.

FIG. 12A is a schematic diagram 3 of a position distribution of reference chroma samples according to an embodiment of this application.

FIG. 12B is a schematic diagram 3 of a position distribution of reference luma samples according to an embodiment of this application.

FIG. 13A is a schematic diagram 4 of a position distribution of reference chroma samples according to an embodiment of this application.

FIG. 13B is a schematic diagram 4 of a position distribution of reference luma samples according to an embodiment of this application.

FIG. 14 is a schematic histogram of gradient intensity values corresponding to an intra prediction mode according to an embodiment of this application.

FIG. 15 is a schematic flowchart 2 of a decoding method according to an embodiment of this application.

FIG. 16 is a schematic flowchart 3 of a decoding method according to an embodiment of this application.

FIG. 17 is a schematic flowchart of an encoding method according to an embodiment of this application.

FIG. 18 is a schematic diagram of a structure of an encoder according to an embodiment of this application.

FIG. 19 is a schematic diagram of a structure of specific hardware of an encoder according to an embodiment of this application.

FIG. 20 is a schematic diagram of a structure of a decoder according to an embodiment of this application.

FIG. 21 is a schematic diagram of a specific hardware structure of a decoder according to an embodiment of this application.

FIG. 22 is a schematic diagram of a structure of a codec system according to an embodiment of this application.

### DESCRIPTION OF EMBODIMENTS

To understand features and technical contents of embodiments of this application in more detail, the following describes implementation of embodiments of this application in detail with reference to the accompanying drawings. The accompanying drawings are merely used for description, and are not intended to limit embodiments of this application.

Unless otherwise defined, all technical and scientific terms used in this specification have the same meaning as commonly understood by those skilled in the technical field of this application. The terms used herein are merely for the purpose of describing embodiments of this application, but are not intended to limit this application.

In the following description, the term “some embodiments” describe a subset of all possible embodiments, but it may be understood that “some embodiments” may be the same subset or different subsets of all possible embodiments and may be combined with each other in the case of no conflicts.

It should be further noted that the term “first/second/third” used in embodiments of this application is merely used to distinguish between similar objects and does not represent a specific order of objects. It may be understood that “first/second/third” may be interchanged in a specific order or sequence if allowed, so that the embodiments of this application described herein may be implemented in a sequence other than the sequence illustrated or described herein.

In a video image, a first color component, a second color component, and a third color component are generally used to represent a coding block (CB). The three color components are a luma component, a blue chroma component, and a red chroma component, respectively. Specifically, the luma component is generally denoted by a symbol Y, the blue chroma component is generally denoted by a symbol Cb or U, and the red chroma component is generally denoted by a symbol Cr or V. In this way, the video image may be represented in a YCbCr format or a YUV format.

It may be understood that, in a current video image or video encoding/decoding process, a cross-component prediction technology mainly includes a cross-component linear model (CCLM) prediction mode and a multi-directional linear model (MDLM) prediction mode. For each of a model factor derived based on the CCLM prediction mode and a model factor derived based on the MDLM prediction mode, a corresponding prediction model can achieve prediction from the first color component to the second color component, from the second color component to the first color component, from the first color component to the third color component, from the third color component to the first color component, from the second color component to the third color component, or from the third color component to the second color component.

The prediction from the first color component to the second color component is used as an example. It is assumed that the first color component is a luma component and the second color component is a chroma component. In order to reduce redundancy between the luma component and the chroma component, the CCLM prediction mode is used in VVC, that is, a chroma prediction value is constructed based on a luma reconstruction value of a same coding block, for example: Pred_{C}(i, j)=α·Rec_{L}(i, j)+β.

In which, i, j represents position coordinates of a to-be-predicted sample in a coding block, i represents a horizontal direction, and j represents a vertical direction. Pred_{C}(i, j) represents a chroma prediction value corresponding to the to-be-predicted sample with position coordinates (i, j) in the coding block, and Rec_{L}(i, j) represents a luma reconstruction value corresponding to the to-be-predicted sample with position coordinates (i, j) in a same coding block (after being downsampled). In addition, α and β represent model factors, which can be derived from reference samples.

In H.266/VVC, there may be a plurality of chroma intra prediction modes, which are: for example, INTRA_LT_CCLM mode, INTRA_L_CCLM mode, and INTRA_T_CCLM mode, where these chroma intra prediction modes are also referred to as cross-component linear model (CCLM) modes; for another example, PLANAR mode, DC mode, ANGULAR18 mode, ANGULAR50 mode, and DM (DM) mode, where these five chroma intra prediction modes are also referred to as non-CCLM modes. In the DM mode, the chroma intra prediction mode may be set to be the same as a luma intra prediction mode.

For example, in ITU-TH.266, referring to Table 1, different values of cclm_mode_flag may correspond to different chroma intra prediction modes (chroma intra modes). For example, when ccm_mode_flag is equal to 0, the chroma intra prediction mode is the non-CCLM mode; when ccm_mode_flag is equal to 1, the chroma intra prediction mode is the CCLM mode.

TABLE 1

| | | | lumaintrapredmode | | | | |
|---|---|---|---|---|---|---|---|
| | | | | | | | X |
| cclm_mode_flag | cclm_mode_idx | Intra_chroma_pred_mode | 0 | 50 | 18 | 1 | (0 <= X <= 66) |
| 0 | — | 0 | 66 | 0 | 0 | 0 | 0 |
| 0 | — | 1 | 50 | 66 | 50 | 50 | 50 |
| 0 | — | 2 | 18 | 18 | 66 | 18 | 18 |
| 0 | — | 3 | 1 | 1 | 1 | 66 | 1 |
| 0 | — | 4 | 0 | 50 | 18 | 1 | X |
| 1 | 0 | — | 81 | 81 | 81 | 81 | 81 |
| 1 | 1 | — | 82 | 82 | 82 | 82 | 82 |
| 1 | 2 | — | 83 | 83 | 83 | 83 | 83 |

It should be noted that, the DM mode in this embodiment of this application refers to a mode in which cclm_mode_flag is equal to 0 and intra_chroma_pred_mode is equal to 4, that is, a chroma intra prediction mode index number is directly set to be equal to a luma intra prediction mode index number. When cclm_mode_flag is equal to 0, values of intra_chroma_pred_mode are equal to the four chroma intra prediction mode index numbers 0 to 3, and may also be determined based on luma intra prediction mode index numbers. The above mode differs from the “DM mode” in that they are not in one-to-one correspondence.

It should be further noted that, in this embodiment of this application, a luma component of the current block may be simply referred to as a luma block, and a chroma component of the current block may be simply referred to as a chroma block. At least one coding unit (CU) may be obtained by dividing the luma block, and may be referred to as “luma CU” in embodiments of this application. At least one coding unit may also be obtained by dividing the chroma block, and may be referred to as “chroma CU” in embodiments of this application.

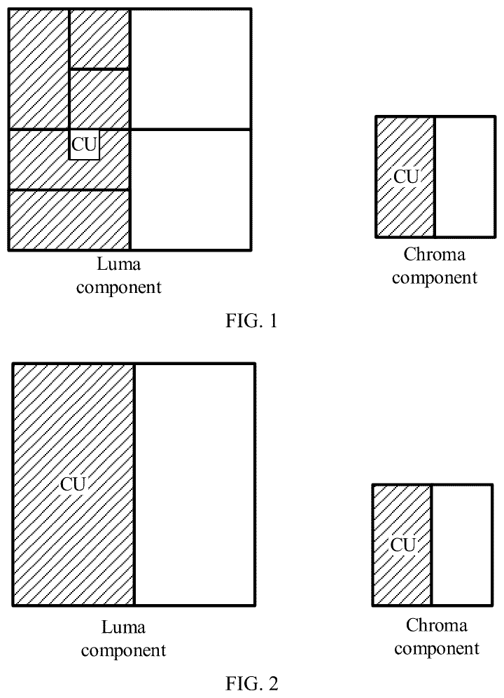

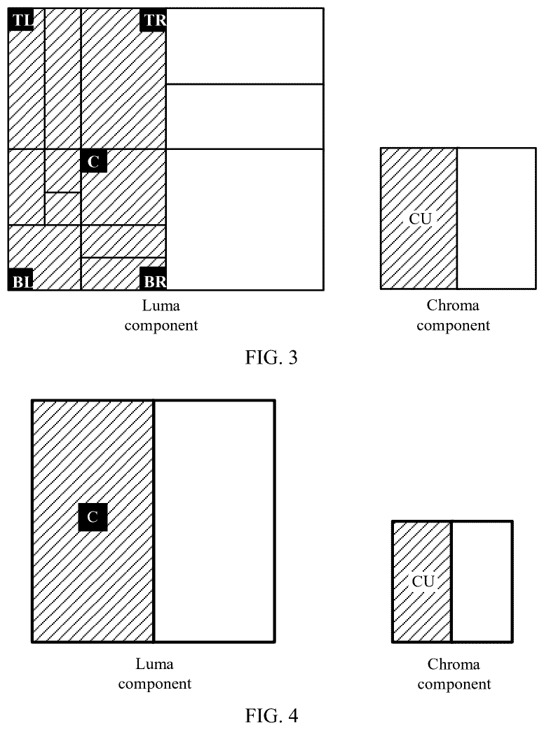

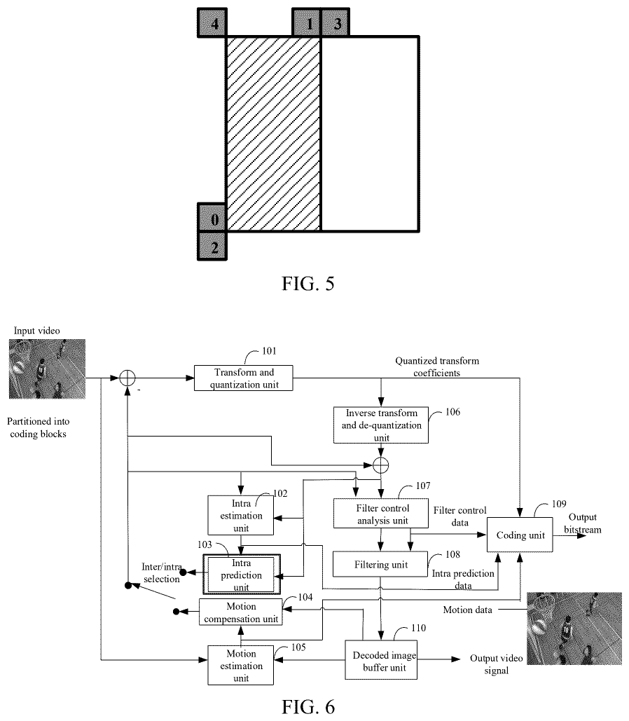

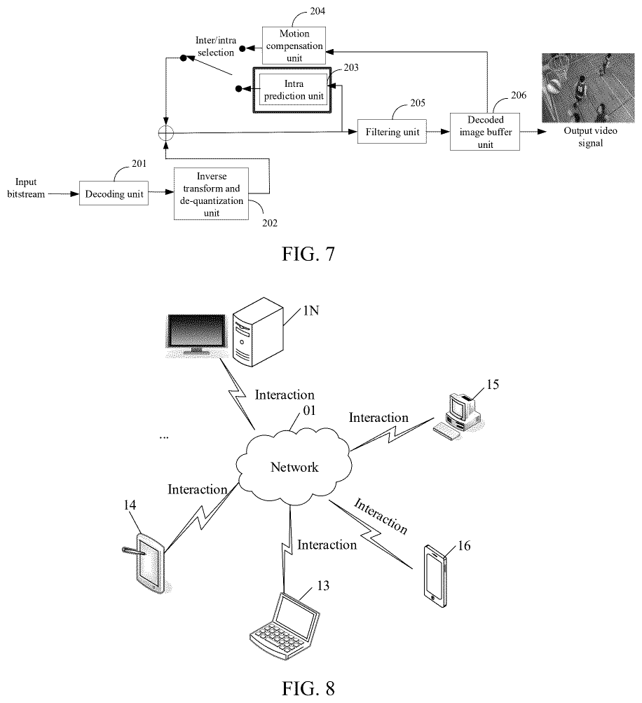

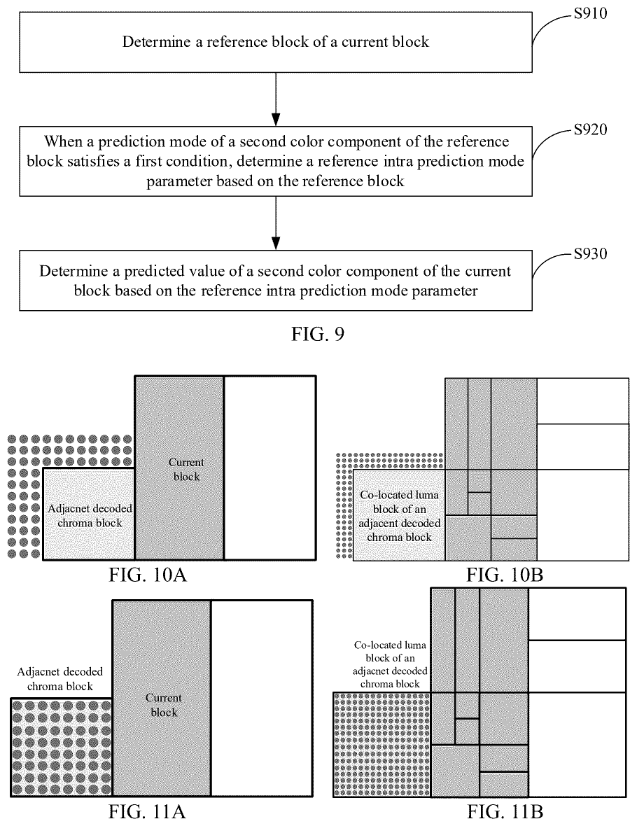

In addition, the DM mode refers to directly using information about a luma prediction mode of a corresponding position. When dual-tree partition is used for an I-frame, independent block partition structures are allowed for a luma block (an entire region filled with diagonal lines in the left figure) and a chroma block (an entire region filled with diagonal lines in the right figure). In this case, a luma component at a position corresponding to a chroma CU may include a plurality of luma CUs, specifically as shown in FIG. 1. In H.266/VVC, a chroma CU inherits an intra prediction mode of a CU at a center position of a corresponding luma block. When single-tree partition is used for an I-frame, a luma block (an entire region filled with diagonal lines in the left figure) and a chroma block (an entire region filled with diagonal lines in the right figure) use a same block partition structure. In this case, a luma component at a corresponding position of a chroma CU includes only one luma CU, as shown in FIG. 2.

In a possible embodiment, in order to better predict the chroma component, it is proposed to add a plurality of conventional prediction modes through a specific derivation process, to improve completeness of available modes for existing chroma prediction. An overall process of this technical solution is described below.

Herein, original five non-CCLM modes are replaced with MaxChromaCandidateListNum chroma prediction modes. The MaxChromaCandidateListNum chroma prediction modes may be sequentially added in the following order, and mutual differences of the modes are ensured. MaxChromaCandidateListNum represents a preset quantity, indicating a maximum quantity of modes that can be stored in this chroma candidate list.

It should be noted that an adding operation in the following steps includes: first establishing a list with a length of MaxChromaCandidateListNum, and then adding all modes to the list in the following order. After the list is constructed, adjustment (including adjustment in order and mode) may be performed. Construction of the list includes the following three cases. In case 1, if the list is constructed in the order of the following steps and is unnecessary to be adjusted after being constructed, an encoding side needs to construct the list, and a decoding side only needs to construct a mode of a list index transmitted in a bitstream. In case 2, if the list is constructed in the order of the following steps and needs to be adjusted after being constructed, the encoding side and the decoding side each need to construct a complete list, and after the list is adjusted, the decoding side selects a mode corresponding to a list index transmitted in a bitstream. In case 3, for the encoding side in case 1, rate distortion optimization is required to be performed on a constructed complete list. There may be a fast algorithm, including but not limited to performing rate distortion optimization only on first several modes. In this case, the encoding side is unnecessary to construct a list of all modes.

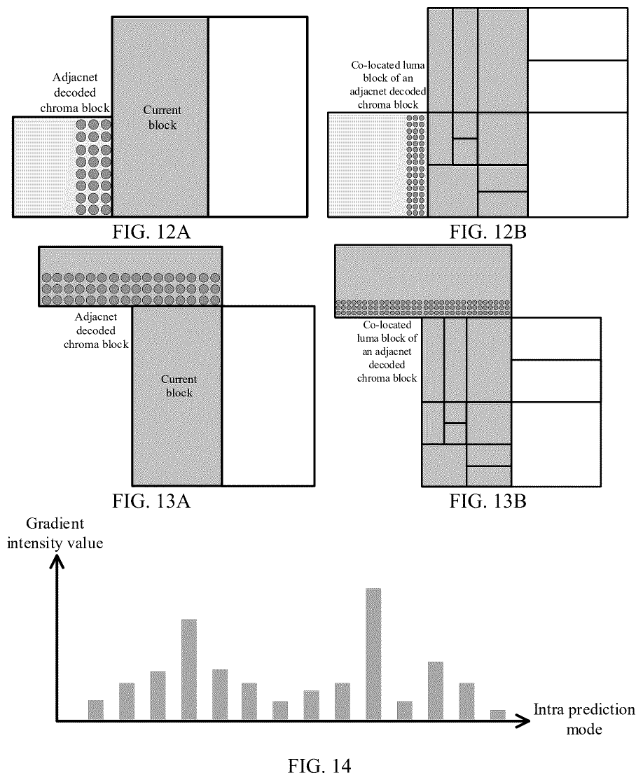

It should be further noted that the adding order of the following steps and the position scanning order of the steps include but are not limited to the order described below. The following steps are provided merely as an example.
(1) Dual-tree partition is used as an example. According to positions shown in FIG. 3, luma intra prediction modes of CUs in which co-located luma blocks C, TL, TR, BL, and BR corresponding to a current chroma coding block are located are sequentially added.

A derivation process for specific positions of C, TL, TR, BL, and BR are as follows:

It is assumed that a position of a corresponding co-located luma sample at an upper-left corner of the current block relative to a position of a luma sample at an upper-left corner of an image (that is, a position of the luma sample TL) is (xCb, yCb), a width of the co-located luma region (that is, an entire region filled with diagonal lines in the left figure) corresponding to the current block is cbWidth, and a height of the co-located luma region is cbHeight.

Coordinates of a position of the luma sample C are (xCb+cbWidth/2, yCb+cbHeight/2).

Coordinates of a position of the luma sample TL are (xCb, yCb).

Coordinates of a position of the luma sample TR are (xCb+cbWidth−1, yCb).

Coordinates of a position of the luma sample BL is (xCb, yCb+cbHeight−1).

Coordinates of a position of the luma sample BR are (xCb+cbWidth−1, yCb+cbHeight−1).

It may be understood that a specific derivation rule for a luma prediction mode of the co-located luma block is as follows:
if a partition tree type treeType is single-tree (SINGLE_TREE), as shown in FIG. 4, a process of adding a luma prediction mode of a CU in which C is located in step (1) is performed;
if a partition tree type treeType is dual-tree (DUAL_TREE), as shown in FIG. 3, the following operations are performed.

The luma prediction mode of the CU in which luma sample C is located is derived as an example. It is assumed that a position of a corresponding co-located luma sample at an upper-left corner of the current block relative to a position of a luma sample at an upper-left corner of an image (that is, a position of the luma sample TL) is (xCb, yCb), a width of the co-located luma region (that is, an entire region filled with diagonal lines in the left figure) corresponding to the current block is cbWidth, and a height of the co-located luma region is cbHeight. A derivation process of a prediction mode lumaIntraPredMode of a corresponding co-located luma block is as follows:
It is determined whether a CU in which a luma sampling point (that is, C) at a center position of the co-located luma region in FIG. 3 is located uses a MIP mode. The center position refers to a luma sampling point with coordinates of (xCb+cbWidth/2, yCb+cbHeight/2).

If IntraMipFlag[xCb+cbWidth/2][yCb+cbHeight/2] is 1, lumaIntraPredMode is set to INTRA PLANAR. The array IntraMipFlag[x][y] indicates whether a current block including a sample point with coordinates of (x, y) uses the MIP mode.

Otherwise, if CuPredMode[0][xCb+cbWidth/2][yCb+cbHeight/2] is MODE_IBC or MODE_PLT, lumaIntraPredMode is set to INTRA_DC. The array CuPredMode[chType][x][y] represents a prediction mode used by a luma or chroma block including a sample point with coordinates of (x, y), and chType being 0 indicates a luma component or chType being 1 indicates a chroma component.

Otherwise, lumaIntraPredMode is set to IntraPredModeY [xCb+cbWidth/2][yCb+cbHeight/2]. The array IntraPredMode Y[x][y] indicates an intra prediction mode used by a current block including a sample point with coordinates of (x, y). For example, Table 2 shows a mapping relationship between a chroma subsampling format of a digital video and sps_chroma_format_idc.

TABLE 2

| sps_chroma_format_idc | Chroma subsampling format |
|---|---|
| 0 | Monochrome |
| 1 | 4:2:0 |
| 2 | 4:2:2 |
| 3 | 4:4:4 |

A specific derivation rule for converting the luma prediction mode of the co-located luma block into a chroma prediction mode is as follows:

When sps_chroma_format_idc is 0, the chroma intra prediction mode is unnecessary to be used, and therefore this derivation rule does not exist.

When sps_chroma_format_idc is 2, mode X of the luma intra prediction mode lumaIntraPredMode specified in Table 3 may be used to derive mode Y of a chroma intra prediction mode.

Otherwise, the chroma intra prediction mode is the same as the luma intra prediction mode lumaIntraPredMode.

For example, Table 3 shows a mapping relationship between luma intra prediction mode X and chroma intra prediction mode Y, which is specifically shown as follows.

TABLE 3

| | | | | | | | | | | | | | | | | | | |
|---|---|---|---|---|---|---|---|---|---|---|---|---|---|---|---|---|---|---|
| Mode X | 0 | 1 | 2 | 3 | 4 | 5 | 6 | 7 | 8 | 9 | 10 | 11 | 12 | 13 | 14 | 15 | 16 | 17 |
| Mode Y | 0 | 1 | 61 | 62 | 63 | 64 | 65 | 66 | 2 | 3 | 5 | 6 | 8 | 10 | 12 | 13 | 14 | 16 |
| Mode X | 18 | 19 | 20 | 21 | 22 | 23 | 24 | 25 | 26 | 27 | 28 | 29 | 30 | 31 | 32 | 33 | 34 | 35 |
| Mode Y | 18 | 20 | 22 | 23 | 24 | 26 | 28 | 30 | 31 | 33 | 34 | 35 | 36 | 37 | 38 | 39 | 40 | 41 |
| Mode X | 36 | 37 | 38 | 39 | 40 | 41 | 42 | 43 | 44 | 45 | 46 | 47 | 48 | 49 | 50 | 51 | 52 | 53 |
| Mode Y | 41 | 42 | 43 | 43 | 44 | 44 | 45 | 45 | 46 | 47 | 48 | 48 | 49 | 49 | 50 | 51 | 51 | 52 |
| Mode X | 54 | 55 | 56 | 57 | 58 | 59 | 60 | 61 | 62 | 63 | 64 | 65 | 66 | | | | | |
| Mode Y | 52 | 53 | 54 | 55 | 55 | 56 | 56 | 57 | 57 | 58 | 59 | 59 | 60 | | | | | |

(2) According to positions shown in FIG. 5, chroma intra prediction modes of encoded/decoded chroma blocks in which reference chroma samples 0, 1, 2, 3, and 4 adjacent to the current block are located are sequentially added in an order.

A detailed position derivation process of the adjacent chroma samples 0, 1, 2, 3, and 4 is explained below:

It is assumed that a position of a chroma sample at an upper-left corner of the current chroma block (an entire area filled with diagonal lines) relative to a chroma sample at an upper-left corner of an image is (xCb, yCb), a width of the current chroma block is cb Width, and a height of the current chroma block is cbHeight.

Position information of chroma sample 0 is (xCb−1, yCb+cbHeight−1).

Position information of chroma sample 1 is (xCb+cbWidth−1, yCb−1).

Position information of chroma sample 2 is (xCb−1, yCb+cbHeight).

Position information of chroma sample 3 is (xCb+cbWidth, yCb−1).

Position information of the chroma sample 4 is (xCb−1, yCb−1).

It may be understood that a specific rule for converting a chroma prediction mode of an adjacent encoded/decoded chroma block into a conventional chroma prediction mode is as follows:
when the prediction mode of the adjacent encoded/decoded chroma block is an inter mode, no adding operation is performed;
when the chroma prediction mode of the adjacent encoded/decoded chroma block is a CCLM mode, no adding operation is performed; or
otherwise, the chroma intra prediction mode of the adjacent encoded/decoded chroma block is directly added.
(3) Modes of which mode index values are obtained by adding mode index values of first two modes among modes added in steps (1) and (2) with +1 or −1 are added. There are two manners herein: in manner 1, determining whether the mode is an angular mode; and if the mode is the angular mode, adding an angular mode obtained by offsetting an angle mapped by the angular mode clockwise or counterclockwise by a minimum angle unit, or if the mode is not the angular mode, performing no operation; and in manner 2, directly adding a corresponding mode index value with +1 or −1: if the mode index value is 0, adding only a mode with a mode index value of 1, or if the mode index value is a maximum mode index, adding a mode with a mode index value of the maximum mode index value minus 1. In addition, if only one mode exists, only two angular modes obtained by offsetting the mode are added. If the mode is not an angular mode, step (3) is not performed.
(4) A preset default non-CCLM mode list is added (the default list includes but is not limited to a subsequent described form). For example, modes in the list are PLANAR_IDX, VER_IDX, HOR_IDX, DC_IDX, VDIA_IDX, VER_IDX-4, VER_IDX+4, HOR_IDX−4, and HOR_IDX+4, respectively.

In short, in the related art, a non-CCLM intra prediction mode list is used to predict a chroma component for a current block, and a CCLM mode of an adjacent encoded/decoded chroma block is ignored. This leads to some defects. For example, a CCLM mode that performs prediction by using a cross-component linear relationship has better prediction effect in encoding/decoding blocks with different content characteristics. Therefore, a large quantity of chroma encoding/decoding blocks of the CCLM mode are used in one frame of image. However, a construction process of the intra prediction mode list of the non-CCLM mode ignores the CCLM mode of the adjacent encoded/decoded chroma block, and some spatial correlation may be lost. That is, obtaining and construction processes of the non-CCLM mode list of existing chroma prediction modes lack completeness, resulting in poor chroma prediction effect.

Based on this, an embodiment of this application provides a decoding method. A reference block of a current block is determined, where the reference block is an adjacent block of the current block; when a prediction mode of a second color component of the reference block satisfies a first condition, a reference intra prediction mode parameter is determined based on the reference block; and a prediction value of a second color component of the current block is determined based on the reference intra prediction mode parameter.

An embodiment of this application further provides an encoding method. A reference block of a current block is determined, where the reference block is an adjacent block of the current block; when a prediction mode of a second color component of the reference block satisfies a first condition, a reference intra prediction mode parameter is determined based on the reference block; a prediction value of a second color component of the current block is determined based on the reference intra prediction mode parameter; and a prediction difference value of the second color component of the current block is determined based on the prediction value of the second color component of the current block.

In this way, for both an encoding side and a decoding side, a related parameter for a reference block adjacent to a current block is analyzed, so that a reference intra prediction mode parameter of a non-CCLM mode can be determined. Based on the reference intra prediction mode parameter, completeness and diversity of chroma intra prediction modes can be improved, so that accuracy of the chroma intra prediction can be improved, and further, encoding and decoding efficiency can be improved, thereby improving encoding and decoding performance.

The following describes embodiments of this application in detail with reference to the accompanying drawings.

Reference is made to FIG. 6, which is a schematic block diagram of a structure of an encoder according to an embodiment of this application. As shown in FIG. 6, an encoder (specifically, a “video encoder”) 100 may include a transform and quantization unit 101, an intra estimation unit 102, an intra prediction unit 103, a motion compensation unit 104, a motion estimation unit 105, an inverse transform and de-quantization unit 106, a filter control analysis unit 107, a filtering unit 108, an encoding unit 109, a decoded image buffer unit 110, and the like. The filtering unit 108 may implement deblocking filtering and sample adaptive offset (SAO) filtering. The encoding unit 109 may implement header information encoding and context-based adaptive binary arithmetic encoding (CABAC). An input original video signal may be subjected to coding tree unit (CTU) partitioning to obtain a video coding block, residual sample information obtained after intra prediction or inter prediction is transformed by the transform and quantization unit 101 for the video coding block, which includes converting the residual information from sample domain into transform domain, and quantizing obtained transform coefficients, to further reduce a bit rate. The intra estimation unit 102 and the intra prediction unit 103 are configured to perform intra prediction on the video coding block. Specifically, the intra estimation unit 102 and the intra prediction unit 103 are configured to determine an intra prediction mode to be used for encoding the video coding block. The motion compensation unit 104 and the motion estimation unit 105 are configured to perform inter prediction encoding of the received video coding block relative to one or more blocks in one or more reference frames, to provide time prediction information. Motion estimation performed by the motion estimation unit 105 generates a motion vector, which may estimate motion of the video coding block. Then, the motion compensation unit 104 performs motion compensation based on the motion vector determined by the motion estimation unit 105. After determining the intra prediction mode, the intra prediction unit 103 is further configured to provide selected intra prediction data to the encoding unit 109, and the motion estimation unit 105 transmits the computed motion vector data also to the encoding unit 109. In addition, the inverse transform and de-quantization unit 106 is configured to reconstruct the video coding block, specifically to reconstruct a residual block in sample domain. The reconstructed residual block is then processed by the filter control analysis unit 107 and the filtering unit 108 to remove blocking artifacts. The reconstructed residual block is subsequently added to a predictive block in a frame in the decoded image buffer unit 110 to generate a reconstructed video coding block. The encoding unit 109 is configured to encode various encoding parameters and quantized transform coefficients. In the CABAC-based encoding algorithm, contextual content, which may be based on neighboring coding blocks, may be used to encode information that indicates the determined intra prediction mode, to output a bitstream for the video signal. The decoded image buffer unit 110 is configured to store the reconstructed video coding block for prediction reference. As video image encoding proceeds, new reconstructed video coding blocks are continuously generated, and these reconstructed video coding blocks are all stored in the decoded image buffer unit 110.

Reference is made to FIG. 7, which is a schematic block diagram of a structure of a decoder according to an embodiment of this application. As shown in FIG. 7, the decoder (specifically, a “video decoder”) 200 includes a decoding unit 201, an inverse transform and de-quantization unit 202, an intra prediction unit 203, a motion compensation unit 204, a filtering unit 205, a decoded image buffer unit 206, and the like. The decoding unit 201 may implement header information decoding and CABAC-based decoding. The filtering unit 205 may implement deblocking filtering and SAO filtering. After the input video signal is encoded as shown in FIG. 6, a bitstream for the video signal is output. The bitstream is input into the decoder 200, and is first processed by the decoding unit 201 to obtain decoded transform coefficients. The transform coefficients are processed by the inverse transform and de-quantization unit 202 to generate a residual block in sample domain. The intra prediction unit 203 may be configured to generate predicted data for a current video decoding block based on the determined intra prediction mode and data from a previously decoded block of a current frame or picture. The motion compensation unit 204 determines predicted information for the video decoding block by analyzing the motion vector and other associated syntax elements, and generates, using the predicted information, a predictive block for the video decoding block being decoded. A decoded video block is generated by summing the residual block from the inverse transform and de-quantization unit 202 and the corresponding predictive block generated by the intra prediction unit 203 or the motion compensation unit 204. The decoded video signal is processed by the filtering unit 205 to remove blocking artifacts, thereby improving video quality. Then, the decoded video block is stored in the decoded image buffer unit 206. The decoded image buffer unit 206 stores a reference image for subsequent intra prediction or motion compensation, and also for output of the video signal, that is, the restored original video signal is obtained.

Further, an embodiment of this application further provides a network architecture of a codec system including an encoder and a decoder. FIG. 8 is a schematic diagram of a network architecture of a codec system according to an embodiment of this application. As shown in FIG. 8, the network architecture includes one or more electronic devices 13 to IN and a communication network 01. The electronic devices 13 to IN may perform video interaction with each other through the communication network 01. The electronic devices may be implemented as various types of devices having a video codec function. For example, the electronic devices may include a smartphone, a tablet computer, a personal computer, a personal digital assistant, a navigator, a digital phone, a videophone, a television, a sensing device, a server, and the like, which is not specifically limited in embodiments of this application. Herein, the decoder or the encoder described in embodiments of this application may be the electronic device described above.

It should be noted that the method in embodiments of this application is mainly applied in the intra prediction unit 103 shown in FIG. 6 and the intra prediction unit 203 shown in FIG. 7. That is, embodiments of this application may be applied to either an encoder or a decoder, or may even be applied to both an encoder and a decoder. However, applications of embodiments of this application are not limited.

It should be further noted that, when the method is applied to the intra prediction unit 103, the “current block” specifically refers to a block that is to be subjected to intra prediction and then encoded. When the method is applied to the intra prediction unit 203, the “current block” specifically refers to a block that is to be subjected to intra prediction and then decoded.

In an embodiment of this application, a method shown in FIG. 9 is applied to a decoder. FIG. 9 is a schematic flowchart 1 of a decoding method according to an embodiment of this application. As shown in FIG. 9, the method may include S910 to S930.

In S910, a reference block of a current block is determined.

It should be noted that the decoding method in this embodiment of this application is applied to a decoding apparatus, or a decoding device integrated with the decoding apparatus (which may also be referred to as a “decoder” for short). In addition, the decoding method in this embodiment of this application may specifically refer to an intra prediction method. Assuming that a first color component is a luma component and a second color component is a chroma component, more specifically, the method herein is a method for deriving a chroma intra prediction mode.

It should be further noted that, in embodiments of this application, the current block includes at least a first color component and a second color component. For the first color component of the current block, the block in this case may be referred to as a first color component block; and when the first color component is a luma component, the first color component block may also be referred to as a luma block. Similarly, for the second color component of the current block, the block in this case may be referred to as a second color component block; and when the second color component is a chroma component, the second color component block may also be referred to as a chroma block.

It should be further noted that, in embodiments of this application, the current block may refer to a decoding block currently to be intra-predicted in a video image. The reference block is an adjacent block of the current block, and the “adjacent” herein may refer to spatial adjacent, temporal adjacent, or the like, without specific limitation. Therefore, when the method is applied to a decoder, the reference block of the current block may be an adjacent decoded block of the current block.

For example, in embodiments of this application, when the method is applied to a decoder, chroma component prediction is used as an example, and a reference chroma block is an adjacent decoded chroma block of the current block.

In S920, when a prediction mode of a second color component of the reference block satisfies a first condition, a reference intra prediction mode parameter is determined based on the reference block.

It should be noted that, in embodiments of this application, if the prediction mode of the second color component of the reference block satisfies the first condition, the reference intra prediction mode parameter may be derived based on the reference block.

In some embodiments, the first condition may include: the prediction mode of the second color component of the reference block is a first preset mode.

In a possible implementation, the first preset mode may be a non-angular prediction mode. For example, the first preset mode may include at least one of the following: an inter-component prediction mode, an IBC mode, a MIP mode, or a palette mode.

It should be understood that, in embodiments of this application, the inter-component prediction mode may be a CCLM mode.

In another possible implementation, the first preset mode may be an inter prediction mode.

That is, in embodiments of this application, if the prediction mode of the second color component of the reference block is the first preset mode, such as the CCLM mode, the reference intra prediction mode parameter may be derived based on the reference block of the current block.

In some embodiments, the first condition may include: the prediction mode of the second color component of the reference block is not a second preset mode.

In still another possible implementation, the second preset mode may be an angular prediction mode.

In still another possible implementation, the second preset mode may be a conventional prediction mode. For example, the second preset mode may be a DC mode or a planar mode.

In other words, in embodiments of this application, if the prediction mode of the second color component of the reference block is not the second preset mode such as the angular prediction mode, the DC mode, or the planar mode, the reference intra prediction mode parameter may also be derived based on the reference block of the current block.

In addition, for the intra prediction mode, the DC mode and the planar mode are used as an example. For example, the DC mode may also be represented by INTRA_DC, and the planar mode may also be represented by INTRA_PLANAR.

In some embodiments, the first condition may include: a bitstream is decoded, and a first parameter is determined, where the first parameter indicates to determine the reference intra prediction mode parameter based on the reference block.

It should also be understood that, in embodiments of this application, the first parameter may be written into the bitstream, and then a decoding side determines the first parameter by decoding the bitstream, where the first parameter indicates that the reference intra prediction mode parameter needs to be determined based on the reference block.

In some embodiments, the process of determining the reference intra prediction mode parameter based on the reference block may include: determining a reference sample based on the reference block; determining a first parameter based on a reconstructed sample value of the reference sample; and determining the reference intra prediction mode parameter based on the first parameter.

In specific embodiments, the process of determining the reference sample according to the reference block may include: determining the reference sample according to a sample in an adjacent region of the reference block, where the adjacent region includes at least one of the following: a left adjacent region, an upper adjacent region, or an upper-left adjacent region.

For example, the left adjacent region of the reference block, the upper adjacent region of the reference block, and the upper-left adjacent region of the reference block, may all be referred to as adjacent regions of the reference block. Referring to FIG. 10A, the current block is a chroma block, and the reference block of the current block is an adjacent decoded chroma block, and an adjacent region of the adjacent decoded chroma block may be a chroma region formed by a plurality of dot samples. Referring to FIG. 10B, the reference block is a co-located luma block of the adjacent decoded chroma block, and an adjacent region of the co-located luma block of the adjacent decoded chroma block may be a luma region formed by a plurality of dot samples.

In another specific embodiment, the process of determining the reference sample based on the reference block may include: determining the reference sample based on a sample in the reference block.

For example, referring to FIG. 11A, the current block is a chroma block, the reference block of the current block is an adjacent decoded chroma block, and the reference sample is a sample in the adjacent decoded chroma block. Referring to FIG. 11B, the reference block is a co-located luma block of the adjacent decoded chroma block, and the reference sample is a sample in the co-located luma block of the adjacent decoded chroma block.

Further, for the first parameter, in some embodiments, the process of determining the first parameter based on the reconstructed sample value of the reference sample may include: calculating a gradient of the reconstructed sample value of the reference sample to determine a horizontal gradient value and a vertical gradient value of the reference sample; performing angle mapping based on the horizontal gradient value and the vertical gradient value of the reference sample to determine at least one intra prediction mode corresponding to the reference sample; calculating gradient intensity based on the horizontal gradient value and the vertical gradient value of the reference sample to determine at least one gradient intensity value corresponding to the reference sample; and determining the first parameter based on the at least one intra prediction mode and the at least one gradient intensity value corresponding to the reference sample.

It may be understood that the reference sample includes at least one candidate sample, and each candidate sample corresponds to an intra prediction mode and a gradient intensity value. Any candidate sample is used as an example. In some embodiments, the process of performing angle mapping based on the horizontal gradient value and the vertical gradient value of the reference sample to determine at least one intra prediction mode corresponding to the reference sample may include: determining a horizontal gradient absolute value and a vertical gradient absolute value of the candidate sample; performing angle mapping based on the horizontal gradient absolute value and the vertical gradient absolute value of the candidate sample to determine an initial mode index value of the candidate sample; and determining, based on the initial mode index value of the candidate sample, an intra prediction mode corresponding to the candidate sample.

It should be noted that, in embodiments of this application, a horizontal gradient value of the candidate sample may be represented by gVer[x][y], and a vertical gradient value of the candidate sample may be represented by gHor[x][y]; in this case, the horizontal gradient absolute value of the candidate sample may be represented by abs(gVer[x][y]), and the vertical gradient absolute value of the candidate sample may be represented by abs(gHor[x][y]). In this way, angle mapping can be performed based on abs(gVer[x][y]) and abs(gHor[x][y]), to determine the initial mode index value of the candidate sample, represented by angIdx[x][y]; then, based on a value of angIdx[x][y], an intra prediction mode corresponding to the candidate sample may be determined.

Further, in some embodiments, the process of determining, based on the initial mode index value of the candidate sample, the intra prediction mode corresponding to the candidate sample may include: compensating the initial mode index value by using a preset angle compensation value to determine a target mode index value of the candidate sample; and determining, based on the target mode index value of the candidate sample, an intra prediction mode corresponding to the candidate sample.

It should be further noted that, in embodiments of this application, the preset angle compensation value may be represented by angOffset[region[x][y]], and the target mode index value of the candidate sample (that is, a corresponding intra prediction mode) may be represented by ipm[x][y]. Herein, a value of ipm[x][y] is equal to a sum of angOffset[region[x][y]] and angIdx[x][y]. Then, the corresponding intra prediction mode may be determined based on the value of ipm[x][y].

It may be further understood that for angOffset[region[x][y]], in some embodiments, the method may further include: determining a target quadrant value of the candidate sample; determining a value corresponding to the target quadrant value according to a preset mapping relationship; and setting the preset angle compensation value to be equal to the value.

It should be noted that, in embodiments of this application, the target quadrant value of the candidate sample may be represented by region[x][y], and the preset mapping relationship may be angOffset={18, 18, 50, 50}. If the target quadrant value is equal to 0 or 1, the preset angle compensation value may be 18; or if the target quadrant value is equal to 2 or 3, the preset angle compensation value may be 50.

Further, in some embodiments, the process of determining the target quadrant value of the candidate sample may include: determining a first symbol value based on a horizontal gradient value of the candidate sample; determining a second symbol value based on a vertical gradient value of the candidate sample; determining a comparison value of the candidate sample based on a comparison result of the horizontal gradient absolute value and the vertical gradient absolute value of the candidate sample; and performing quadrant mapping based on the comparison value, the first symbol value, and the second symbol value to determine the target quadrant value corresponding to the candidate sample.

It should be further noted that, in embodiments of this application, the first symbol value may be expressed as signV[x][y], which is used to indicate whether gVer[x][y] is greater than 0 or less than 0; the second symbol value may be expressed as signH[x][y], which is used to indicate whether gHor[x][y] is greater than 0 or less than 0; and the comparison value may be expressed as HgV[x][y], which is used to indicate whether abs(gHor[x][y]) is greater than abs(gVer[x][y]). In this way, the target quadrant value region[x][y] may be determined based on sign V[x][y], signH[x][y], and HgV[x][y].

It may also be understood that, in some embodiments, the process of calculating gradient intensity based on the horizontal gradient value and the vertical gradient value of the reference sample to determine at least one gradient intensity value corresponding to the reference sample may include: calculating a sum of the horizontal gradient absolute value and the vertical gradient absolute value of the candidate sample to determine a gradient intensity value corresponding to the candidate sample.

In embodiments of this application, a gradient intensity value corresponding to the candidate sample may be represented by iAmp[x][y], whose value is equal to a sum of abs(gVer[x][y]) and abs(gHor[x][y]).

In embodiments of this application, the reconstructed sample value of the reference sample includes at least one of the following: a reconstructed sample value of a first color component of the reference sample; or a reconstructed sample value of a second color component of the reference sample.

In a specific embodiment, the process of determining the first parameter based on the reconstructed sample value of the reference sample may include: when the reconstructed sample value of the reference sample is the reconstructed sample value of the first color component of the reference sample, determining at least one intra prediction mode and at least one gradient intensity value corresponding to the first color component of the reference sample; when the reconstructed sample value of the reference sample is the reconstructed sample value of the second color component of the reference sample, determining at least one intra prediction mode and at least one gradient intensity value corresponding to the second color component of the reference sample; forming a first set based on the at least one intra prediction mode corresponding to the first color component of the reference sample and the at least one intra prediction mode corresponding to the second color component of the reference sample, where the first set includes at least one reference intra prediction mode with different characteristics; accumulating, based on the at least one gradient intensity value corresponding to the first color component of the reference sample and the at least one gradient intensity value corresponding to the second color component of the reference sample, gradient intensity values belonging to a same reference intra prediction mode, to determine a gradient intensity value corresponding to the at least one reference intra prediction mode; and determining the first parameter based on the at least one reference intra prediction mode and the gradient intensity value corresponding to the at least one reference intra prediction mode.

The following describes an example of determining the at least one intra prediction mode and the at least one gradient intensity value corresponding to the reference sample with reference to FIG. 10A to FIG. 13B.

In a possible implementation, the reference sample is determined based on a sample in an adjacent region of the reference block, and then at least one intra prediction mode and at least one gradient intensity value corresponding to the reference sample are determined based on the reference sample, where the reference sample includes at least one candidate sample.

For example, referring to FIG. 10A, the current block is a chroma block, and the reference block is an adjacent decoded chroma block. It is assumed that a width of the adjacent decoded chroma block is CbNbWidth, and a height of the adjacent decoded chroma block is CbNbHeight. Assuming that coordinate information of a candidate chroma sample is pC[x][y], x∈[−3, CbNbWidth], y∈[−3, −1], x∈[−3, −1], and y∈[0, CbNbHeight], where an origin [0] is sample coordinate of an upper-left corner of the adjacent decoded chroma block, and the candidate chroma sample is located in a chroma region formed by a plurality of dots in FIG. 10A. Referring to FIG. 10B, the YUV420 format is used as an example, and in this case, for a co-located luma block of the adjacent decoded chroma block, a width is 2×CbNb Width, and a height is 2×CbNbHeight. Assuming that coordinate information of a candidate luma sample is pY[x][y], x∈[−3,2×CbNbWidth], y∈[−3, −1], x∈[−3, −1], and y∈[0, 2×CbNbHeight], where the origin [0][0] is sample coordinate of an upper-left corner of the co-located luma block of the adjacent decoded chroma block, and the candidate luma sample is located in a luma region formed by a plurality of dots in FIG. 10B.

The following provides pseudocode for determining an intra prediction mode and a gradient intensity value corresponding to a candidate sample. In the following pseudocode, angOffset is a preset angle compensation value, gHor[x][y] is a vertical gradient value, gVer[x][y] is a horizontal gradient value, signH[x][y] is a second symbol value, signV[x][y] is a first symbol value, region[x][y] is a target quadrant value, ipm[x][y] is an intra prediction mode, and iAmp[x][y] is a gradient intensity value.

Let mapHgV={{2, 1}, {1, 2}}, mapVgH={{3, 4}, {4, 3}}, and angTable={0, 2048, 4096, 6144, 8192, 12288, 16384, 20480, 24576, 28672, 32768, 36864, 40960, 47104, 53248, 59392, 65536}; and
let the preset angle compensation value angOffset={18, 18, 50, 50}.
Step (1): For coordinate information of a candidate chroma sample pC[x][y], to be specific, x∈[−3, CbNbWidth], y=−2, x=−2, and y∈[0, CbNbHeight], the following values are calculated:

$$vertical gradient value : gHor [ x ] [ y ] = pC [ x - 1 ] [ y - 1 ] + 2 \times pC [ x - 1 ] [ y ] + pC [ x - 1 ] [ y + 1 ] - pC [ x + 1 ] [ y - 1 ] - 2 \times pC [ x + 1 ] [ y ] - pC [ x + 1 ] [ y + 1 ] ; \\ horizontal gradient value : gVer [ x ] [ y ] = pC [ x - 1 ] [ y - 1 ] + 2 \times pC [ x ] [ y - 1 ] + pC [ x + 1 ] [ y - 1 ] - pC [ x - 1 ] [ y + 1 ] - 2 \times pC [ x ] [ y + 1 ] - pC [ x + 1 ] [ y + 1 ] ; \\ second symbol value : signH [ x ] [ y ] = gHor [ x ] [ y ] < 0 ? 1 : 0 ; \\ first symbol value : signV [ x ] [ y ] = gVer [ x ] [ y ] < 0 ? 1 : 0 ; \\ comparison value : HgV [ x ] [ y ] = ( abs ( gHor [ x ] [ y ] ) > abs ( gVer [ x ] [ y ] ) ? 1 : 0 ) ; \\ target quadrant value : region [ x ] [ y ] = ( HgV [ x ] [ y ] == 1 ? mapHgV [ signH [ x ] [ y ] ] [ signV [ x ] [ y ] ] : mapVg [ signH [ x ] [ y ] ] [ signV [ x ] [ y ] ] ) ; \\ grad [ x ] [ y ] = ( HgV [ x ] [ y ] == 1 ? abs ( gVer [ x ] [ y ] ) / abs ( gHor [ x ] [ y ] ) : abs ( gHor [ x ] [ y ] ) / abs ( gVer [ x ] [ y ] ) ) ; \\ grad [ x ] [ y ] = round ( grad [ x ] [ y ] * ( 1 << 16 ) ) ; \\ initial mode index value : angIdx [ x ] [ y ] = argmini ( abs ( angTable [ i ] - grad [ x ] [ y ] ) ) ; \\ intra prediction mode : ipm [ x ] [ y ] = angOffset [ region [ x ] [ y ] ] + angIdx [ x ] [ y ] ; \\ and \\ gradient intensity value : iAmp [ x ] [ y ] = abs ( gHor [ x ] [ y ] ) + abs ( gVer [ x ] [ y ] ) .$$

Step (2): For coordinate information of a candidate luma sample pY[x][y], to be specific, x∈[−3, 2×CbNbWidth], y=−2, x=−2, and y∈[0,2 x CbNbHeight], the following values are calculated:

$$vertical gradient value : gHor [ x ] [ y ] = pY [ x - 1 ] [ y - 1 ] + 2 \times pY [ x - 1 ] [ y ] + pY [ x - 1 ] [ y + 1 ] - pY [ x + 1 ] [ y - 1 ] - 2 \times pY [ x + 1 ] [ y ] - pY [ x + 1 ] [ y + 1 ] ; \\ horizontal gradient value : gVer [ x ] [ y ] = pY [ x - 1 ] [ y - 1 ] + 2 \times pY [ x ] [ y - 1 ] + pY [ x + 1 ] [ y - 1 ] - pY [ x - 1 ] [ y + 1 ] - 2 \times pY [ x ] [ y + 1 ] - pY [ x + 1 ] [ y + 1 ] ; \\ second symbol value : signH [ x ] [ y ] = gHor [ x ] [ y ] < 0 ? 1 : 0 ; \\ first symbol value : signV [ x ] [ y ] = gVer [ x ] [ y ] < 0 ? 1 : 0 ; \\ comparison value : HgV [ x ] [ y ] = ( abs ( gHor [ x ] [ y ] ) > abs ( gVer [ x ] [ y ] ) ? 1 : 0 ) ; \\ target quadrant value : region [ x ] [ y ] = ( HgV [ x ] [ y ] == 1 ? mapHgV [ signH [ x ] [ y ] ] [ signV [ x ] [ y ] ] : mapVg [ signH [ x ] [ y ] ] [ signV [ x ] [ y ] ] ) ; \\ grad [ x ] [ y ] = ( HgV [ x ] [ y ] == 1 ? abs ( gVer [ x ] [ y ] ) / abs ( gHor [ x ] [ y ] ) : abs ( gHor [ x ] [ y ] ) / abs ( gVer [ x ] [ y ] ) ) ; \\ grad [ x ] [ y ] = round ( grad [ x ] [ y ] * ( 1 << 16 ) ) ; \\ initial mode index value : angIdx [ x ] [ y ] = argmini ( abs ( angTable [ i ] - grad [ x ] [ y ] ) ) ; \\ intra prediction mode : ipm [ x ] [ y ] = angOffset [ region [ x ] [ y ] ] + angIdx [ x ] [ y ] ; \\ and \\ gradient intensity value : iAmp [ x ] [ y ] = abs ( gHor [ x ] [ y ] ) + abs ( gVer [ x ] [ y ] ) .$$

In another possible implementation, the reference sample is determined based on all sample s in an adjacent region of the reference block, and then at least one intra prediction mode and at least one gradient intensity value corresponding to the reference sample are determined based on the reference sample, where the reference sample includes at least one candidate sample.

For example, referring to FIG. 11A, the current block is a chroma block, and the reference block is an adjacent decoded chroma block. It is assumed that a width of the adjacent decoded chroma block is CbNbWidth and a height of the adjacent decoded chroma block is CbNbHeight. Assuming that coordinate information of a candidate chroma sample is pC[x][y], x∈[0, CbNbWidth−1] and y∈[0, CbNbHeight−1], where an origin[0][0] is sample coordinate of an upper-left corner of the adjacent decoded chroma block, and the candidate chroma sample is located in a chroma region formed by a plurality of dots in FIG. 11A. Referring to FIG. 11B, the YUV420 format is used as an example, and in this case, for a co-located luma block of the adjacent decoded chroma block, a width is 2×CbNbWidth, and a height is 2×CbNbHeight. Assuming that coordinate information of a candidate luma sample is pY[x][y], x∈[0, 2×CbNbWidth−1] and y∈[0, 2×CbNbHeight−1], where the origin [0][0] is sample coordinate of an upper-left corner of the co-located luma block of the adjacent decoded chroma block, and the candidate luma sample is located in a luma region formed by a plurality of dots in FIG. 11B.

The following provides pseudocode for determining an intra prediction mode and a gradient intensity value corresponding to a candidate sample. In the following pseudocode, angOffset is a preset angle compensation value, gHor[x][y] is a vertical gradient value, gVer[x][y] is a horizontal gradient value, signH[x][y] is a second symbol value, signV[x][y] is a first symbol value, region[x][y] is a target quadrant value, ipm[x][y] is an intra prediction mode, and iAmp[x][y] is a gradient intensity value.

Let mapHgV={{2, 1}, {1, 2}}, mapVgH={{3, 4}, {4, 3}}, and angTable={0, 2048, 4096, 6144, 8192, 12288, 16384, 20480, 24576, 28672, 32768, 36864, 40960, 47104, 53248, 59392, 65536}; and
let the preset angle compensation value angOffset={18, 18, 50, 50}.
Step (1): For coordinate information of a candidate chroma sample pC[x][y], to be specific, x∈[1, CbNbWidth−2] and y∈[1, CbNbHeight−2], the following values are calculated:

$$vertical gradient value : gHor [ x ] [ y ] = pC [ x - 1 ] [ y - 1 ] + 2 \times pC [ x - 1 ] [ y ] + pC [ x - 1 ] [ y + 1 ] - pC [ x + 1 ] [ y - 1 ] - 2 \times pC [ x + 1 ] [ y ] - pC [ x + 1 ] [ y + 1 ] ; \\ horizontal gradient value : gVer [ x ] [ y ] = pC [ x - 1 ] [ y - 1 ] + 2 \times pC [ x ] [ y - 1 ] + pC [ x + 1 ] [ y - 1 ] - pC [ x - 1 ] [ y + 1 ] - 2 \times pC [ x ] [ y + 1 ] - pC [ x + 1 ] [ y + 1 ] ; \\ second symbol value : signH [ x ] [ y ] = gHor [ x ] [ y ] < 0 ? 1 : 0 ; \\ first symbol value : signV [ x ] [ y ] = gVer [ x ] [ y ] < 0 ? 1 : 0 ; \\ comparison value : HgV [ x ] [ y ] = ( abs ( gHor [ x ] [ y ] ) > abs ( gVer [ x ] [ y ] ) ? 1 : 0 ) ; \\ target quadrant value : region [ x ] [ y ] = ( HgV [ x ] [ y ] == 1 ? mapHgV [ signH [ x ] [ y ] ] [ signV [ x ] [ y ] ] : mapVg [ signH [ x ] [ y ] ] [ signV [ x ] [ y ] ] ) ; \\ grad [ x ] [ y ] = ( HgV [ x ] [ y ] == 1 ? abs ( gVer [ x ] [ y ] ) / abs ( gHor [ x ] [ y ] ) : abs ( gHor [ x ] [ y ] ) / abs ( gVer [ x ] [ y ] ) ) ; \\ grad [ x ] [ y ] = round ( grad [ x ] [ y ] * ( 1 << 16 ) ) ; \\ initial mode index value : angIdx [ x ] [ y ] = argmini ( abs ( angTable [ i ] - grad [ x ] [ y ] ) ) ; \\ intra prediction mode : ipm [ x ] [ y ] = angOffset [ region [ x ] [ y ] ] + angIdx [ x ] [ y ] ; \\ and \\ gradient intensity value : iAmp [ x ] [ y ] = abs ( gHor [ x ] [ y ] ) + abs ( gVer [ x ] [ y ] ) .$$

Step (2): For coordinate information of a candidate luma sample pY[x][y], to be specific, x∈[1, 2×CbNbWidth−2] and y∈[1, 2×CbNbHeight−2], the following values are calculated:

$$vertical gradient value : gHor [ x ] [ y ] = pY [ x - 1 ] [ y - 1 ] + 2 \times pY [ x - 1 ] [ y ] + pY [ x - 1 ] [ y + 1 ] - pY [ x + 1 ] [ y - 1 ] - 2 \times pY [ x + 1 ] [ y ] - pY [ x + 1 ] [ y + 1 ] ; \\ horizontal gradient value : gVer [ x ] [ y ] = pY [ x - 1 ] [ y - 1 ] + 2 \times pY [ x ] [ y - 1 ] + pY [ x + 1 ] [ y - 1 ] - pY [ x - 1 ] [ y + 1 ] - 2 \times pY [ x ] [ y + 1 ] - pY [ x + 1 ] [ y + 1 ] ; \\ second symbol value : signH [ x ] [ y ] = gHor [ x ] [ y ] < 0 ? 1 : 0 ; \\ first symbol value : signV [ x ] [ y ] = gVer [ x ] [ y ] < 0 ? 1 : 0 ; \\ comparison value : HgV [ x ] [ y ] = ( abs ( gHor [ x ] [ y ] ) > abs ( gVer [ x ] [ y ] ) ? 1 : 0 ) ; \\ target quadrant value : region [ x ] [ y ] = ( HgV [ x ] [ y ] == 1 ? mapHgV [ signH [ x ] [ y ] ] [ signV [ x ] [ y ] ] : mapVg [ signH [ x ] [ y ] ] [ signV [ x ] [ y ] ] ) ; \\ grad [ x ] [ y ] = ( HgV [ x ] [ y ] == 1 ? abs ( gVer [ x ] [ y ] ) / abs ( gHor [ x ] [ y ] ) : abs ( gHor [ x ] [ y ] ) / abs ( gVer [ x ] [ y ] ) ) ; \\ grad [ x ] [ y ] = round ( grad [ x ] [ y ] * ( 1 << 16 ) ) ; \\ initial mode index value : angIdx [ x ] [ y ] = argmini ( abs ( angTable [ i ] - grad [ x ] [ y ] ) ) ; \\ intra prediction mode : ipm [ x ] [ y ] = angOffset [ region [ x ] [ y ] ] + angIdx [ x ] [ y ] ; \\ and \\ gradient intensity value : iAmp [ x ] [ y ] = abs ( gHor [ x ] [ y ] ) + abs ( gVer [ x ] [ y ] ) .$$

In still another possible implementation, because determining the reference sample based on all samples in the reference block increases calculation complexity, the reference sample can be determined based on a part of samples in the reference block, and then at least one intra prediction mode and at least one gradient intensity value corresponding to the reference sample can be determined based on the reference sample, where the reference sample includes at least one candidate sample.

For example, referring to FIG. 12A, the current block is a chroma block, and the reference block is an adjacent decoded chroma block. It is assumed that a width of the adjacent decoded chroma block is CbNbWidth and a height the adjacent decoded chroma block is CbNbHeight. Assuming that coordinate information of a candidate chroma sample is pC[x][y], x∈[CbNbWidth−3, CbNbWidth−1] and y∈[0, CbNbHeight−1], where an origin[0][0] is sample coordinate of an upper-left corner of the adjacent decoded chroma block, and the candidate chroma sample is located in a chroma region formed by a plurality of dots in FIG. 12A. Referring to FIG. 12B, the YUV420 format is used as an example, and in this case, for a co-located luma block of the adjacent decoded chroma block, a width is 2×CbNbWidth, and a height is 2×CbNbHeight. Assuming that coordinate information of a candidate luma sample is pY[x][y], x∈[2×CbNbWidth−3, 2×CbNbWidth−1] and y∈[0, 2×CbNbHeight−1], where the origin [0][0] is sample coordinate of an upper-left corner of the co-located luma block of the adjacent decoded chroma block, and the candidate luma sample is located in a luma region formed by a plurality of dots in FIG. 12B.

The following provides pseudocode for determining an intra prediction mode and a gradient intensity value corresponding to a candidate sample. In the following pseudocode, angOffset is a preset angle compensation value, gHor[x][y] is a vertical gradient value, g Ver[x][y] is a horizontal gradient value, signH[x][y] is a second symbol value, signV[x][y] is a first symbol value, region[x][y] is a target quadrant value, ipm[x][y] is an intra prediction mode, and iAmp[x][y] is a gradient intensity value.

Let mapHgV={{2, 1}, {1, 2}}, map VgH={{3, 4}, {4, 3}}, and angTable={0, 2048, 4096, 6144, 8192, 12288, 16384, 20480, 24576, 28672, 32768, 36864, 40960, 47104, 53248, 59392.65536}; and
let the preset angle compensation value angOffset={18, 18, 50, 50}.
Step (1): For coordinate information of a candidate chroma sample pC[x][y], to be specific, x=CbNbWidth−2 and y∈[1, CbNbHeight−2], the following values are calculated:

$$vertical gradient value : gHor [ x ] [ y ] = pC [ x - 1 ] [ y - 1 ] + 2 \times pC [ x - 1 ] [ y ] + pC [ x - 1 ] [ y + 1 ] - pC [ x + 1 ] [ y - 1 ] - 2 \times pC [ x + 1 ] [ y ] - pC [ x + 1 ] [ y + 1 ] ; \\ horizontal gradient value : gVer [ x ] [ y ] = pC [ x - 1 ] [ y - 1 ] + 2 \times pC [ x ] [ y - 1 ] + pC [ x + 1 ] [ y - 1 ] - pC [ x - 1 ] [ y + 1 ] - 2 \times pC [ x ] [ y + 1 ] - pC [ x + 1 ] [ y + 1 ] ; \\ second symbol value : signH [ x ] [ y ] = gHor [ x ] [ y ] < 0 ? 1 : 0 ; \\ first symbol value : signV [ x ] [ y ] = gVer [ x ] [ y ] < 0 ? 1 : 0 ; \\ comparison value : HgV [ x ] [ y ] = ( abs ( gHor [ x ] [ y ] ) > abs ( gVer [ x ] [ y ] ) ? 1 : 0 ) ; \\ target quadrant value : region [ x ] [ y ] = ( HgV [ x ] [ y ] == 1 ? mapHgV [ signH [ x ] [ y ] ] [ signV [ x ] [ y ] ] : mapVg [ signH [ x ] [ y ] ] [ signV [ x ] [ y ] ] ) ; \\ grad [ x ] [ y ] = ( HgV [ x ] [ y ] == 1 ? abs ( gVer [ x ] [ y ] ) / abs ( gHor [ x ] [ y ] ) : abs ( gHor [ x ] [ y ] ) / abs ( gVer [ x ] [ y ] ) ) ; \\ grad [ x ] [ y ] = round ( grad [ x ] [ y ] * ( 1 << 16 ) ) ; \\ initial mode index value : angIdx [ x ] [ y ] = argmini ( abs ( angTable [ i ] - grad [ x ] [ y ] ) ) ; \\ intra prediction mode : ipm [ x ] [ y ] = angOffset [ region [ x ] [ y ] ] + angIdx [ x ] [ y ] ; \\ and \\ gradient intensity value : iAmp [ x ] [ y ] = abs ( gHor [ x ] [ y ] ) + abs ( gVer [ x ] [ y ] ) .$$

Step (2): For coordinate information of a candidate luma sample pY[x][y], to be specific, x=2×CbNbWidth−2] and y∈[1,2×CbNbHeight−2], the following values are calculated:

$$vertical gradient value : gHor [ x ] [ y ] = pY [ x - 1 ] [ y - 1 ] + 2 \times pY [ x - 1 ] [ y ] + pY [ x - 1 ] [ y + 1 ] - pY [ x + 1 ] [ y - 1 ] - 2 \times pY [ x + 1 ] [ y ] - pY [ x + 1 ] [ y + 1 ] ; \\ horizontal gradient value : gVer [ x ] [ y ] = pY [ x - 1 ] [ y - 1 ] + 2 \times pY [ x ] [ y - 1 ] + pY [ x + 1 ] [ y - 1 ] - pY [ x - 1 ] [ y + 1 ] - 2 \times pY [ x ] [ y + 1 ] - pY [ x + 1 ] [ y + 1 ] ; \\ second symbol value : signH [ x ] [ y ] = gHor [ x ] [ y ] < 0 ? 1 : 0 ; \\ first symbol value : signV [ x ] [ y ] = gVer [ x ] [ y ] < 0 ? 1 : 0 ; \\ comparison value : HgV [ x ] [ y ] = ( abs ( gHor [ x ] [ y ] ) > abs ( gVer [ x ] [ y ] ) ? 1 : 0 ) ; \\ target quadrant value : region [ x ] [ y ] = ( HgV [ x ] [ y ] == 1 ? mapHgV [ signH [ x ] [ y ] ] [ signV [ x ] [ y ] ] : mapVg [ signH [ x ] [ y ] ] [ signV [ x ] [ y ] ] ) ; \\ grad [ x ] [ y ] = ( HgV [ x ] [ y ] == 1 ? abs ( gVer [ x ] [ y ] ) / abs ( gHor [ x ] [ y ] ) : abs ( gHor [ x ] [ y ] ) / abs ( gVer [ x ] [ y ] ) ) ; \\ grad [ x ] [ y ] = round ( grad [ x ] [ y ] * ( 1 << 16 ) ) ; \\ initial mode index value : angIdx [ x ] [ y ] = argmini ( abs ( angTable [ i ] - grad [ x ] [ y ] ) ) ; \\ intra prediction mode : ipm [ x ] [ y ] = angOffset [ region [ x ] [ y ] ] + angIdx [ x ] [ y ] ; \\ and \\ gradient intensity value : iAmp [ x ] [ y ] = abs ( gHor [ x ] [ y ] ) + abs ( gVer [ x ] [ y ] ) .$$

In still another possible implementation, another reference sample position is used as an example. Because determining the reference sample based on all samples in the reference block increases calculation complexity, the reference sample can be determined based on a part of samples in the reference block, and then at least one intra prediction mode and at least one gradient intensity value corresponding to the reference sample can be determined based on the reference sample, where the reference sample includes at least one candidate sample.

For example, referring to FIG. 13A, the current block is a chroma block, and the reference block is an adjacent decoded chroma block. It is assumed that a width of the adjacent decoded chroma block is CbNbWidth and a height the adjacent decoded chroma block is CbNbHeight. Assuming that coordinate information of a candidate chroma sample is pC[x][y], x∈[0, CbNbWidth−1] and y∈[CbNbHeight−3, CbNbHeight−1], where an origin [0][0] is sample coordinate of an upper-left corner of the adjacent decoded chroma block, and the candidate chroma sample is located in a chroma region formed by a plurality of dots in FIG. 13A. Referring to FIG. 13B, the YUV420 format is used as an example, and in this case, for a co-located luma block of the adjacent decoded chroma block, a width is 2×CbNbWidth, and a height is 2×CbNbHeight. Assuming that coordinate information of a candidate luma sample is pY[x][y], x∈[0, 2×CbNbWidth−1] and y∈[2×CbNbHeight−3, 2×CbNbHeight−1], where the origin [0][0] is sample coordinate of an upper-left corner of the co-located luma block of the adjacent decoded chroma block, and the candidate luma sample is located in a luma region formed by a plurality of dots in FIG. 13B.

The following provides pseudocode for determining an intra prediction mode and a gradient intensity value corresponding to a candidate sample. In the following pseudocode, angOffset is a preset angle compensation value, gHor[x][y] is a vertical gradient value, g Ver[x][y] is a horizontal gradient value, signH[x][y] is a second symbol value, signV[x][y] is a first symbol value, region[x][y] is a target quadrant value, ipm[x][y] is an intra prediction mode, and iAmp[x][y] is a gradient intensity value.

Let mapHgV={{2, 1}, {1, 2}}, mapVgH={{3, 4}, {4, 3}}, and angTable={0, 2048, 4096, 6144, 8192, 12288, 16384, 20480, 24576, 28672, 32768, 36864, 40960, 47104, 53248, 59392, 65536}; and
let the preset angle compensation value angOffset={18, 18, 50, 50}.

Step (1): For coordinate information of a candidate chroma sample pC[x][y], to be specific, x=[0, CbNbWidth−1] and y=CbNbHeight−2, the following values are calculated:

$$vertical gradient value : gHor [ x ] [ y ] = pC [ x - 1 ] [ y - 1 ] + 2 \times pC [ x - 1 ] [ y ] + pC [ x - 1 ] [ y + 1 ] - pC [ x + 1 ] [ y - 1 ] - 2 \times pC [ x + 1 ] [ y ] - pC [ x + 1 ] [ y + 1 ] ; \\ horizontal gradient value : gVer [ x ] [ y ] = pC [ x - 1 ] [ y - 1 ] + 2 \times pC [ x ] [ y - 1 ] + pC [ x + 1 ] [ y - 1 ] - pC [ x - 1 ] [ y + 1 ] - 2 \times pC [ x ] [ y + 1 ] - pC [ x + 1 ] [ y + 1 ] ; \\ second symbol value : signH [ x ] [ y ] = gHor [ x ] [ y ] < 0 ? 1 : 0 ; \\ first symbol value : signV [ x ] [ y ] = gVer [ x ] [ y ] < 0 ? 1 : 0 ; \\ comparison value : HgV [ x ] [ y ] = ( abs ( gHor [ x ] [ y ] ) > abs ( gVer [ x ] [ y ] ) ? 1 : 0 ) ; \\ target quadrant value : region [ x ] [ y ] = ( HgV [ x ] [ y ] == 1 ? mapHgV [ signH [ x ] [ y ] ] [ signV [ x ] [ y ] ] : mapVg [ signH [ x ] [ y ] ] [ signV [ x ] [ y ] ] ) ; \\ grad [ x ] [ y ] = ( HgV [ x ] [ y ] == 1 ? abs ( gVer [ x ] [ y ] ) / abs ( gHor [ x ] [ y ] ) : abs ( gHor [ x ] [ y ] ) / abs ( gVer [ x ] [ y ] ) ) ; \\ grad [ x ] [ y ] = round ( grad [ x ] [ y ] * ( 1 << 16 ) ) ; \\ initial mode index value : angIdx [ x ] [ y ] = argmini ( abs ( angTable [ i ] - grad [ x ] [ y ] ) ) ; \\ intra prediction mode : ipm [ x ] [ y ] = angOffset [ region [ x ] [ y ] ] + angIdx [ x ] [ y ] ; \\ and \\ gradient intensity value : iAmp [ x ] [ y ] = abs ( gHor [ x ] [ y ] ) + abs ( gVer [ x ] [ y ] ) .$$

Step (2): For coordinate information of a candidate luma sample pY[x][y], to be specific, x=[0,2×CbNbWidth−1] and y=2×CbNbHeight−2, the following values are calculated:

$$vertical gradient value : gHor [ x ] [ y ] = pY [ x - 1 ] [ y - 1 ] + 2 \times pY [ x - 1 ] [ y ] + pY [ x - 1 ] [ y + 1 ] - pY [ x + 1 ] [ y - 1 ] - 2 \times pY [ x + 1 ] [ y ] - pY [ x + 1 ] [ y + 1 ] ; \\ horizontal gradient value : gVer [ x ] [ y ] = pY [ x - 1 ] [ y - 1 ] + 2 \times pY [ x ] [ y - 1 ] + pY [ x + 1 ] [ y - 1 ] - pY [ x - 1 ] [ y + 1 ] - 2 \times pY [ x ] [ y + 1 ] - pY [ x + 1 ] [ y + 1 ] ; \\ second symbol value : signH [ x ] [ y ] = gHor [ x ] [ y ] < 0 ? 1 : 0 ; \\ first symbol value : signV [ x ] [ y ] = gVer [ x ] [ y ] < 0 ? 1 : 0 ; \\ comparison value : HgV [ x ] [ y ] = ( abs ( gHor [ x ] [ y ] ) > abs ( gVer [ x ] [ y ] ) ? 1 : 0 ) ; \\ target quadrant value : region [ x ] [ y ] = ( HgV [ x ] [ y ] == 1 ? mapHgV [ signH [ x ] [ y ] ] [ signV [ x ] [ y ] ] : mapVg [ signH [ x ] [ y ] ] [ signV [ x ] [ y ] ] ) ; \\ grad [ x ] [ y ] = ( HgV [ x ] [ y ] == 1 ? abs ( gVer [ x ] [ y ] ) / abs ( gHor [ x ] [ y ] ) : abs ( gHor [ x ] [ y ] ) / abs ( gVer [ x ] [ y ] ) ) ; \\ grad [ x ] [ y ] = round ( grad [ x ] [ y ] * ( 1 << 16 ) ) ; \\ initial mode index value : angIdx [ x ] [ y ] = argmini ( abs ( angTable [ i ] - grad [ x ] [ y ] ) ) ; \\ intra prediction mode : ipm [ x ] [ y ] = angOffset [ region [ x ] [ y ] ] + angIdx [ x ] [ y ] ; \\ and \\ gradient intensity value : iAmp [ x ] [ y ] = abs ( gHor [ x ] [ y ] ) + abs ( gVer [ x ] [ y ] ) .$$

It should be noted that the initial mode index value is a calculated mode index value closest to an index value of intra prediction mode; and after the initial mode index value is compensated using a preset angle compensation value angOffset[region[x][y]], a calculated intra prediction mode can be determined.

For example, FIG. 14 is a schematic histogram of gradient intensity values corresponding to at least one intra prediction mode according to an embodiment of this application. As shown in FIG. 14, gradient values iAmp of steps (1) and (2) in any one of the foregoing implementations may be accumulated based on a corresponding intra prediction mode ipm, and a histogram may be established with the intra prediction mode ipm as a horizontal coordinate and a gradient intensity value iAmp as a vertical coordinate. The histogram may include gradient intensity values corresponding to at least one intra prediction mode, and a mode index range of the at least one intra prediction mode is [0, 66].

In some embodiments, the process of determining the reference intra prediction mode parameter based on the first parameter may include: forming a second set based on the gradient intensity value corresponding to the at least one reference intra prediction mode; and if each gradient intensity value in the second set is zero, determining the reference intra prediction mode parameter based on a PLANAR mode; or if there is a non-zero gradient intensity value in the second set, determining a largest gradient intensity value from the second set, and determining the reference intra prediction mode parameter based on an intra prediction mode corresponding to the largest gradient intensity value.

For example, as shown in FIG. 14, the second set may include a gradient intensity value corresponding to at least one intra prediction mode. FIG. 14 intuitively illustrates: a largest gradient intensity value in the gradient intensity values corresponding to the at least one intra prediction mode, and an intra prediction mode corresponding to the largest gradient intensity value.

Further, in some embodiments, −1 is assigned to the largest gradient intensity value in the second set to determine a third set; and if the intra prediction mode corresponding to the largest gradient intensity value is the same as a first color component prediction mode of a first color component block co-located with the reference block, a new largest gradient intensity value is determined from the third set, and the reference intra prediction mode parameter is determined based on an intra prediction mode corresponding to the new largest gradient intensity value.

Further, in some embodiments, if the intra prediction mode corresponding to the new largest gradient intensity value is the same as the first color component prediction mode of the first color component block co-located with the reference block, the reference intra prediction mode parameter is determined based on a DC mode.

In embodiments of this application, the reference intra prediction mode parameter derived from the histogram shown in FIG. 14 is represented by IntraPredModeD, and a mode index range of the reference intra prediction mode parameter is [0, 66].

For example, if there is no non-zero gradient intensity value, IntraPredModeD=INTRA_PLANAR.

Otherwise, IntraPredModeD is set to argmax i(HoG[i]), and HoG[IntraPredModeD] is set to −1.

If IntraPredModeD is the same as a DM mode of a chroma block in which (xCbNb, yCbNb) is located, searching is performed again, and IntraPredModeD is set to argmax i (HoG[i]).

If IntraPredModeD is still the same as the DM mode of the chroma block in which (xCbNb, yCbNb) is located, IntraPredModeD is set to INTRA_DC.

In S930, a predicted value of a second color component of the current block is determined based on the reference intra prediction mode parameter.

It should be noted that, in embodiments of this application, the process of determining the predicted value of the second color component of the current block based on the reference intra prediction mode parameter may include: constructing a candidate mod list for the second color component of the current block based on the reference intra prediction mode parameter; and determining the predicted value of the second color component of the current block based on the candidate mode list.

In some embodiments, the process of determining the predicted value of the second color component of the current block based on the candidate mode list may include: parsing a bitstream to determine a mode index number of the second color component of the current block; determining, based on the candidate mode list, a target prediction mode corresponding to the mode index number; and performing prediction on the second color component of the current block using the target prediction mode, to determine the predicted value of the second color component of the current block.

It should be noted that, in embodiments of this application, after establishing the candidate mode list, the decoding side can determine the target prediction mode by using the mode index number obtained by decoding; and then perform prediction on the second color component of the current block using the target prediction mode, to determine the predicted value of the second color component of the current block.

Further, in some embodiments, the method may further include: parsing a bitstream to determine a predicted difference value of the second color component of the current block; and determining a reconstructed value of the second color component of the current block based on the predicted value of the second color component of the current block and the predicted difference value of the second color component of the current block.

It should be further noted that, in embodiments of this application, an encoding side already determines the predicted difference value of the second color component of the current block and writes the difference value into the bitstream. After obtaining the predicted difference value by decoding, the decoding side can perform an addition operation on the predicted value of the second color component of the current block and the predicted difference value of the second color component of the current block, to obtain the reconstructed value of the second color component of the current block.

In other words, the chroma component is used as an example, and a candidate mode list for a chroma component of the current block is constructed based on the reference intra prediction mode parameter. Because in a construction process, texture analysis is performed by fully utilizing content characteristics of the adjacent decoded reference block, to construct a gradient histogram corresponding to a plurality of angular modes, a gradient intensity value is determined using a horizontal gradient value and a vertical gradient value, and then a reference intra prediction mode parameter can be determined and added to a candidate mode list, thereby improving diversity of chroma intra prediction modes. Further, a more accurate chroma prediction value can be obtained based on the candidate mode list, thereby improving accuracy of chroma intra prediction.

It should also be understood that in embodiments of this application, for the reference block of the current block, in some embodiments, the process of determining the reference block of the current block may further include: determining at least one target sample adjacent to the current block; determining at least one first target block based on a block in which the at least one target sample is located; and determining the reference block of the current block based on the at least one first target block.

For example, referring to FIG. 5, the current block (an entire region filled with diagonal lines) is a chroma block, a target sample adjacent to the current block may be a sample 0, a block in which the sample 0 is located may be a first target block, and the first target block is a reference block of the current block.

Further, in some embodiments, a reference intra prediction mode parameter of the at least one first target block is determined by sequentially using the at least one first target block as the reference block in a first preset order; and the candidate mode list for the second color component of the current block is constructed based on the reference intra prediction mode parameter of the at least one first target block.

It should be understood that the first preset order may be set manually or according to a specific rule in a specific scenario, which is not limited in embodiments of this application.

For example, referring to FIG. 5, the current block (an entire region filled with diagonal lines) is a chroma block, and 0, 1, 2, 3, and 4 are target samples. Assuming that coordinates of an upper-left corner of the current block relative to a chroma sample in an upper-left corner of an image are (xCb, yCb), a width of the current block is cbWidth, and a height of the current block is cbHeight, coordinate information of 0, 1, 2, 3, and 4 is as follows.

Coordinates of the target sample 0 are (xCb−1, yCb+cbHeight−1).

Coordinates of the target sample 1 are (xCb+cbWidth−1, yCb−1).

Coordinates of the target sample 2 are (xCb−1, yCb+cbHeight).

Coordinates of the target sample 3 are (xCb+cbWidth, yCb−1).

Coordinates of the target sample 4 are (xCb−1, yCb−1).

Based on the coordinates of the target samples 0, 1, 2, 3, and 4, blocks in which the target samples 0, 1, 2, 3, and 4 are located respectively can be determined, and the blocks in which the target samples 0, 1, 2, 3, and 4 are located respectively can be used as five first target blocks respectively. The five first target blocks can be sequentially used as reference blocks, to determine reference intra prediction mode parameters of the five first target blocks with reference to the method described above, so that the candidate mode list for the second color component of the current block can be constructed based on the reference intra prediction mode parameters of the five first target blocks.

In addition, in some embodiments, the method may further include: determining the prediction mode of the second color component of the reference block; and when the prediction mode of the second color component of the reference block does not satisfy the first condition, directly adding the prediction mode of the second color component of the reference block to the candidate mode list.

For example, in embodiments of this application, if the prediction mode of the second color component of the reference block is an intra prediction mode other than the inter prediction mode and the CCLM mode, the candidate mode list for the second color component of the current block can be constructed based on the prediction mode of the second color component of the reference block, that is, the prediction mode of the second color component of the reference block can be directly added to the candidate mode list.

Embodiments of this application provide a decoding method. After a reference block of a current block is determined, a reference intra prediction mode parameter can be determined based on the reference block when a prediction mode of a second color component of the reference block meets a first condition; a candidate mode list for a second color component of the current block can be constructed based on the reference intra prediction mode parameter; and a prediction value of the second color component of the current block can be determined based on the candidate mode list. In this way, a reference intra prediction mode parameter of a non-CCLM mode is determined with reference to a prediction mode of an adjacent decoded reference block, so that not only completeness and diversity of chroma intra prediction modes can be improved, and but also accuracy of chroma intra prediction can be improved, thereby improving decoding efficiency and thus improving decoding performance.

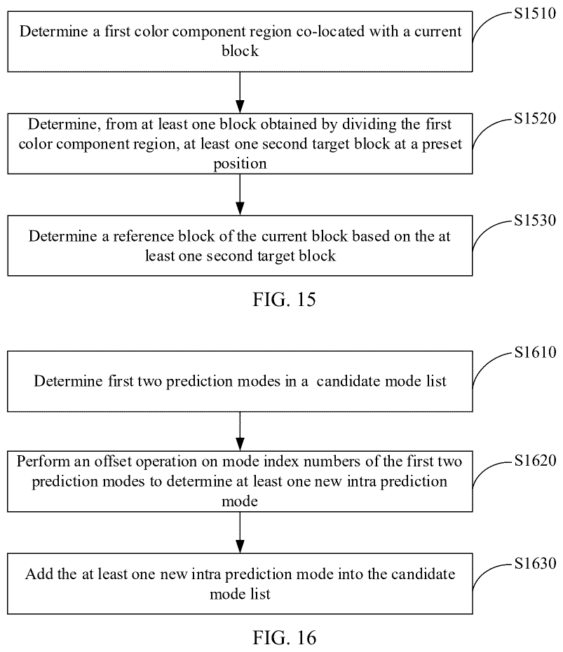

In another embodiment of this application, reference is made to FIG. 15, which is a schematic flowchart 2 of a decoding method based on the decoding method in the foregoing embodiment according to an embodiment of this application. As shown in FIG. 15, the method may include S1510 to S1530.

In S1510, a first color component region co-located with a current block is determined.

For example, referring to FIG. 3 or FIG. 4, the current block is a chroma block (an entire region filled with diagonal lines in the right figure of FIG. 3 or FIG. 4), and the first color component region co-located with the current block is a luma block (an entire region filled with diagonal lines in the left figure of FIG. 3 or FIG. 4).

In S1520, from at least one block obtained by dividing the first color component region, at least one second target block at a preset position is determined.

For example, in a single-tree mode, referring to FIG. 4, the first color component region includes one block, and a second target block at the preset position is block C.

For example, in a dual-tree mode, referring to FIG. 3, the first color component region is divided into a plurality of blocks, and there are five second target blocks at the preset positions, which are respectively denoted as block TL, block TR, block C, block BL, and block BR.

As shown in FIG. 3, it is assumed that a position of a corresponding co-located luma block at an upper-left corner of the current block relative to a luma block at an upper-left corner of an image (that is, a position of luma block TL) is (xCb, yCb), for a co-located luma region (an entire region filled with diagonal lines in the left figure) corresponding to the current block, a width is cb Width, and a height is chHeight. In this case, position coordinates of the five second target blocks may be denoted as follows.

Coordinates of block C are (xCb+cbWidth/2, yCb+cbHeight/2).

Coordinates of block TL are (xCb, yCb).

Coordinates of block TR are (xCb+cbWidth−1, yCb).

Coordinates of block BL are (xCb, yCb+cbHeight−1).

Coordinates of block BR are (xCb+cbWidth−1, yCb+cbHeight−1).

It should be understood that the five positions of the second target blocks shown in

FIG. 3 are for exemplary purposes only, the positions of the second target blocks are not limited in embodiments of this application, and a plurality of different positions may be used. A quantity and specific positions of the second target blocks are not limited in embodiments of this application.

In S1530, the reference block of the current block is determined based on the at least one second target block.

For example, one of the at least one second target block may be used as the reference block of the current block. For example, block C in FIG. 4 is used as the reference block of the current block.

For example, a plurality of second target blocks may be used as reference blocks of the current block. For example, block C, block TL, block TR, block BL, and block BR in FIG. 3 are sequentially used as reference blocks of the current block.

In some embodiments, the method may further include: sequentially determining a first color component prediction mode parameter of the at least one second target block in a preset order of the at least one second target block; and constructing the candidate mode list for the second color component of the current block based on the first color component prediction mode parameter of the at least one second target block.

It should be understood that when there is only one second target block, the preset order of the second target blocks is unnecessary to be considered.

It should also be understood that the preset order may be set manually or according to a specific rule in a specific scenario, which is not limited in embodiments of this application. For example, referring to FIG. 3, a preset order of second target blocks may include but is not limited to the following order: C->TL->TR->BL->BR.

For example, a process of determining the first color component prediction mode parameter of the at least one second target block is described below.

In one example, in a single-tree mode, referring to FIG. 4, the first color component prediction mode parameter of the second target block may be a first color component prediction mode of block C.

In another example, in a dual-tree mode, referring to FIG. 3, assuming that the second target block is block C in FIG. 3, the process of determining a first color component prediction mode parameter of block C in FIG. 3 may include the following steps 1 to 3.

In step 1, it is determined whether block C in FIG. 3 uses a MIP mode.

If block C in FIG. 3 uses the MIP mode, the first color component prediction mode parameter of block C in FIG. 3 is set as a PLANAR mode. The above process may be expressed by pseudocode as follows: If IntraMipFlag[xCb+cbWidth/2][yCb+cbHeight/2] is equal to 1, lumaIntraPredMode is set to INTRA_PLANAR. (xCb+cbWidth/2, yCb+cbHeight/2) is coordinate information of block C; IntraMipFlag[xCb+cbWidth/2][yCb+cbHeight/2] is an array, indicating whether block C uses the MIP mode; and lumaIntraPredMode is the first color component prediction mode parameter, and INTRA_PLANAR is the PLANAR mode.

Otherwise, if block C in FIG. 3 does not use the MIP mode, step 2 is performed.

In step 2, if CuPredMode[0][xCb+cbWidth/2][yCb+cbHeight/2] is an IBC mode or a PLT mode, the first color component prediction mode parameter of block C is set as the DC mode. (xCb+cbWidth/2, yCb+cbHeight/2) is coordinate information of block C, and [0] is the first color component.

Otherwise, if CuPredMode[0][xCb+cbWidth/2][yCb+cbHeight/2] is not the IBC mode or the PLT mode, step 3 is performed.

In step 3, the prediction mode parameter of the first color component of block C is set as IntraPredModeY[xCb+cbWidth/2][yCb+cbHeight/2], where (xCb+cbWidth/2, yCb+cbHeight/2) is the coordinate information of block C.

It should be understood that determining a first color component prediction mode parameter of a block (such as block TL or block TR) other than block C in FIG. 3 is similar to determining the first color component prediction mode parameter of block C, and details are not described herein again.

Further, in some embodiments, the candidate mode list for the second color component of the current block may be constructed based on the first color component prediction mode parameter of the at least one second target block in the following two possible implementations.

In a possible implementation, the first color component prediction mode parameter of the at least one second target block is added to the candidate mode list for the second color component of the current block.

For example, in the single-tree mode, referring to FIG. 4, the first color component prediction mode of block C may be added to the candidate mode list for the second color component of the current block.

For example, in the dual-tree mode, referring to FIG. 3, assuming that the second target block is block C in FIG. 3, and the first color component prediction mode parameter of block C is the PLANAR mode, the PLANAR mode may be added to the candidate mode list for the second color component of the current block.

In another possible implementation, referring to the foregoing Table 2, in a chroma subsampling format, the first color component prediction mode parameter of the at least one second target block may need to be converted before being added to the candidate mode list for the second color component of the current block.

For example, when sps_chroma_format_idc is 0, it is unnecessary to convert the first color component prediction mode parameter of the at least one second target block, and in this case, the first color component prediction mode parameter of the at least one second target block is unnecessary to be added to the candidate mode list for the second color component of the current block.

For example, when sps_chroma_format_idc is 2, referring to the foregoing Table 3, the first color component prediction mode parameter of the at least one second target block is converted using a preset rule specified in Table 3, to obtain a converted first color component prediction mode parameter of the at least one second target block; and the converted first color component prediction mode parameter of the second target block is added to the candidate mode list for the second color component of the current block.

For example, when sps_chroma_format_idc is 1 or 3, it is unnecessary to convert the first color component prediction mode parameter of the at least one second target block, and in this case, the first color component prediction mode parameter of the at least one second target block may be directly added to the candidate mode list for the second color component of the current block.

It should be noted that, according to the decoding method shown in FIG. 9, the candidate mode list for the second color component of the current block can be constructed based on the reference intra prediction mode parameter of the at least one first target block; and according to the decoding method shown in FIG. 15, the candidate mode list for the second color component of the current block can be constructed based on the first color component prediction mode parameter of the at least one second target block. Based on this, the candidate mode list for the second color component of the current block can be constructed based on the reference intra prediction mode parameter of the at least one first target block and the first color component prediction mode parameter of the at least one second target block.

In still another embodiment of this application, reference is made to FIG. 16, which is a schematic flowchart 3 of a decoding method based on the decoding method in the foregoing embodiment according to an embodiment of this application. As shown in FIG. 16, the method may include S1610 to S1630.

In S1610, first two prediction modes in a candidate mode list are determined.

The candidate mode list may be constructed based on a reference intra prediction mode parameter of at least one first target block, or based on a first color component prediction mode parameter of at least one second target block, or may be constructed based on both the reference intra prediction mode parameter of the at least one first target block and the first color component prediction mode parameter of the at least one second target block.

In S1620, an offset operation is performed on mode index numbers of the first two prediction modes to determine at least one new intra prediction mode.

It should be noted that, in a possible implementation, for the first two prediction modes in the candidate mode list, it is first determined whether the prediction mode is an angular mode. If the prediction mode is the angular mode, an angle mapped by the angular mode is offset clockwise or counterclockwise by a minimum angle unit to obtain a mapped angular mode, and the mapped angular mode is used as a new intra prediction mode. If the prediction mode is not the angular mode, a new intra prediction mode is not determined.

In another possible implementation, a mode index number of the prediction mode is directly increased by 1 or decreased by 1. In this scenario, there are the following special cases: If the mode index number is 0, a prediction mode with a mode index number of 1 is used as the new intra prediction mode; or if the mode index number is a largest mode index number, a prediction mode corresponding to the largest mode index number minus 1 is used as the new intra prediction mode. If there is a single prediction mode, it is determined whether the single mode is an angular mode; and if the single mode is the angular mode, the angular mode is used as a new intra prediction mode; or if the single mode is not the angular mode, a new intra prediction mode is not determined.

In S1630, the at least one new intra prediction mode is added into the candidate mode list.

In embodiments of this application, when the at least one new intra prediction mode is to be added into the candidate mode list, intra prediction modes in the candidate mode list are required to have different characteristics.

In embodiments of this application, after the at least one new intra prediction mode is added into the candidate mode list, the candidate mode list may be constructed by using the new intra prediction mode, or by using the new intra prediction mode and the reference intra prediction mode parameter of the at least one first target block, or by using the new intra prediction mode and the first color component prediction mode parameter of the at least one second target block, or by using the new intra prediction mode, the reference intra prediction mode parameter of the at least one first target block, and the first color component prediction mode parameter of the at least one second target block. The construction manner of the candidate mode list is not limited in embodiments of this application.

It should be noted that, in embodiments of this application, the offset operation is performed on the mode index numbers of the first two prediction modes in the candidate mode list to determine at least one new intra prediction mode, and the at least one new intra prediction mode is added into the candidate mode list. In this way, not only completeness and diversity of chroma intra prediction modes can be improved, but also accuracy of chroma intra prediction can be improved, thereby improving decoding efficiency and thus improving decoding performance.

It should be further noted that, in embodiments of this application, the candidate mode list can also be constructed using a preset intra prediction mode. The preset intra prediction mode may be at least one of the following: PLANAR_IDX, VER_IDX, HOR_IDX, DC_IDX, VDIA_IDX, VER_IDX−4, VER_IDX+4, HOR_IDX−4, or HOR_IDX+4.

In embodiments of this application, the candidate mode list may be constructed by using one or a combination of the following four methods: constructing the candidate mode list by using the preset intra prediction mode, constructing the candidate mode list by using the new intra prediction mode, constructing the candidate mode list by using the reference intra prediction mode parameter of the at least one first target block, and constructing the candidate mode list by using the first color component prediction mode of the at least one second target block. The construction manner of the candidate mode list is not limited in embodiments of this application.

It should be understood that, in embodiments of this application, an order of prediction modes in the candidate mode list may be adjusted.

It should also be understood that, in embodiments of this application, intra prediction modes in the candidate mode list have different characteristics.

Embodiments of this application provide a decoding method. The candidate mode list can be constructed by using the preset intra prediction mode, or the candidate mode list can be constructed by using the new intra prediction mode, the candidate mode list can be constructed by using the reference intra prediction mode parameter of the at least one first target block, or the candidate mode list can be constructed by using the first color component prediction mode of the at least one second target block. In addition, the candidate mode list may be constructed by using one or a combination of these four methods. In this way, not only completeness and diversity of chroma intra prediction modes can be improved, but also accuracy of chroma intra prediction can be improved, thereby improving decoding efficiency and thus improving decoding performance.

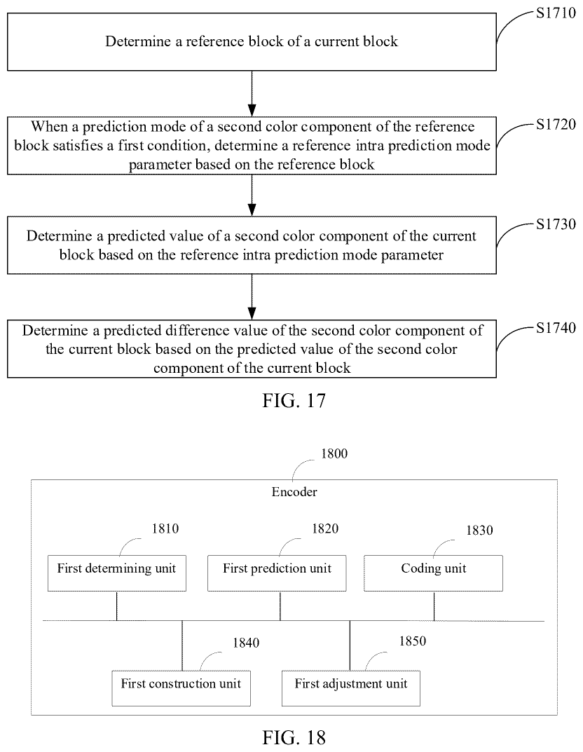

In still another embodiment of this application, a method shown in FIG. 17 is applied to an encoder. FIG. 17 is a schematic flowchart of an encoding method according to an embodiment of this application. As shown in FIG. 17, the method may include S1710 to S1740.

In S1710, a reference block of a current block is determined.

It should be noted that the encoding method in this embodiment of this application is applied to an encoding apparatus, or an encoding device integrated with the encoding apparatus (which may also be referred to as an “encoder” for short). In addition, the encoding method in this embodiment of this application may specifically refer to an intra prediction method. Assuming that a first color component is a luma component and a second color component is a chroma component, more specifically, the method herein is a method for deriving a chroma intra prediction mode.

It should be further noted that, in embodiments of this application, the current block may refer to an encoder block currently to be intra-predicted in a video image. The reference block is an adjacent block of the current block, and the “adjacent” herein may refer to spatial adjacent, temporal adjacent, or the like, without specific limitation. Therefore, when the method is applied to an encoder, the reference block of the current block may be an adjacent encoded block of the current block.

For example, in embodiments of this application, when the method is applied to an encoder, chroma component prediction is used as an example, and a reference chroma block is an adjacent encoded chroma block of the current block.

In S1720, when a prediction mode of a second color component of the reference block satisfies a first condition, a reference intra prediction mode parameter is determined based on the reference block.

It should be noted that, in embodiments of this application, if the prediction mode of the second color component of the reference block satisfies the first condition, the reference intra prediction mode parameter may be derived based on the reference block.

In some embodiments, the first condition may include: the prediction mode of the second color component of the reference block is a first preset mode.

In a possible implementation, the first preset mode may be a non-angular prediction mode. For example, the first preset mode includes at least one of the following: an inter-component prediction mode, an IBC mode, a MIP mode, or a palette mode.

The inter-component prediction mode may be a CCLM mode.

In another possible implementation, the first preset mode is an inter prediction mode.

That is, in embodiments of this application, if the prediction mode of the second color component of the reference block is the first preset mode, such as the CCLM mode, the reference intra prediction mode parameter may be derived based on the reference block of the current block.

In some embodiments, the first condition may include: the prediction mode of the second color component of the reference block is not a second preset mode.

In still another possible implementation, the second preset mode is an angular prediction mode.

In still another possible implementation, the second preset mode is a conventional prediction mode. For example, the second preset mode may be a DC mode or a planar mode.

In other words, in embodiments of this application, if the prediction mode of the second color component of the reference block is not the second preset mode such as the angular prediction mode, the DC mode, or the planar mode, the reference intra prediction mode parameter may also be derived based on the reference block of the current block.

In some embodiments, the first condition may include: a first parameter is determined, where the first parameter indicates to determine the reference intra prediction mode parameter based on the reference block; and the method further includes: encoding the first parameter to obtain encoded bits, and writing the encoded bits into a bitstream.

It should also be understood that, in embodiments of this application, the first parameter may also be written into the bitstream, and then a decoding side determines the first parameter by decoding the bitstream, where the first parameter indicates that the reference intra prediction mode parameter needs to be determined based on the reference block.

In some embodiments, the process of determining the reference intra prediction mode parameter based on the reference block may include: determining a reference sample based on the reference block; determining a first parameter based on a reconstructed sample value of the reference sample; and determining the reference intra prediction mode parameter based on the first parameter.

In a specific embodiment, the process of determining the reference sample according to the reference block may include: determining the reference sample according to a sample in an adjacent region of the reference block, where the adjacent region includes at least one of the following: a left adjacent region, an upper adjacent region, or an upper-left adjacent region.

In another specific embodiment, the process of determining the reference sample based on the reference block may include: determining the reference sample based on a sample of the reference block.

Further, for the first parameter, in some embodiments, the process of determining the first parameter based on the reconstructed sample value of the reference sample may include: calculating a gradient of the reconstructed sample value of the reference sample to determine a horizontal gradient value and a vertical gradient value of the reference sample; performing angle mapping based on the horizontal gradient value and the vertical gradient value of the reference sample to determine at least one intra prediction mode corresponding to the reference sample; calculating gradient intensity based on the horizontal gradient value and the vertical gradient value of the reference sample to determine at least one gradient intensity value corresponding to the reference sample; and determining the first parameter based on the at least one intra prediction mode and the at least one gradient intensity value corresponding to the reference sample.

In embodiments of this application, the reference sample includes at least one candidate sample, and each candidate sample corresponds to an intra prediction mode and a gradient intensity value. Any candidate sample is used as an example. In some embodiments, the process of performing angle mapping based on the horizontal gradient value and the vertical gradient value of the reference sample to determine at least one intra prediction mode corresponding to the reference sample may include: determining a horizontal gradient absolute value and a vertical gradient absolute value of the candidate sample; performing angle mapping based on the horizontal gradient absolute value and the vertical gradient absolute value of the candidate sample to determine an initial mode index value of the candidate sample; and determining, based on the initial mode index value of the candidate sample, an intra prediction mode corresponding to the candidate sample.

Further, in some embodiments, the process of determining, based on the initial mode index value of the candidate sample, the intra prediction mode corresponding to the candidate sample may include: compensating the initial mode index value by using a preset angle compensation value to determine a target mode index value of the candidate sample; and determining, based on the target mode index value of the candidate sample, an intra prediction mode corresponding to the candidate sample.

Further, in some embodiments, the method further includes: determining a target quadrant value of the candidate sample; determining a value corresponding to the target quadrant value according to a preset mapping relationship; and setting the preset angle compensation value to be equal to the value.

Further, in some embodiments, the process of determining the target quadrant value of the candidate sample may include: determining a first symbol value based on a horizontal gradient value of the candidate sample; and determining a second symbol value based on a vertical gradient value of the candidate sample; determining a comparison value of the candidate sample based on a comparison result of the horizontal gradient absolute value and the vertical gradient absolute value of the candidate sample; and performing quadrant mapping based on the comparison value, the first symbol value, and the second symbol value to determine the target quadrant value corresponding to the candidate sample.

Further, in some embodiments, the process of calculating gradient intensity n based on the horizontal gradient value and the vertical gradient value of the reference sample to determine at least one gradient intensity value corresponding to the reference sample may include: calculating a sum of the horizontal gradient absolute value and the vertical gradient absolute value of the candidate sample to determine a gradient intensity value corresponding to the candidate sample.

In embodiments of this application, the reconstructed sample value of the reference sample includes at least one of the following: a reconstructed sample value of a first color component of the reference sample; or a reconstructed sample value of a second color component of the reference sample.

In this way, for the first parameter, in a specific embodiment, the process of determining the first parameter based on the reconstructed sample value of the reference sample may include: when the reconstructed sample value of the reference sample is the reconstructed sample value of the first color component of the reference sample, determining at least one intra prediction mode and at least one gradient intensity value corresponding to the first color component of the reference sample; or when the reconstructed sample value of the reference sample is the reconstructed sample value of the second color component of the reference sample, determining at least one intra prediction mode and at least one gradient intensity value corresponding to the second color component of the reference sample; forming a first set based on the at least one intra prediction mode corresponding to the first color component of the reference sample and the at least one intra prediction mode corresponding to the second color component of the reference sample, where the first set includes at least one reference intra prediction mode with different characteristics; accumulating, based on the at least one gradient intensity value corresponding to the first color component of the reference sample and the at least one gradient intensity value corresponding to the second color component of the reference sample, gradient intensity values belonging to a same reference intra prediction mode, to determine a gradient intensity value corresponding to the at least one reference intra prediction mode; and determining the first parameter based on the at least one reference intra prediction mode and the gradient intensity value corresponding to the at least one reference intra prediction mode.

For example, when embodiments of this application are applied to an encoder, the exemplary description of determining the at least one intra prediction mode and the at least one gradient intensity value corresponding to the reference sample is similar to that on a decoder side. Details are not described herein again.

In some embodiments, the process of determining the reference intra prediction mode parameter based on the first parameter may include: forming a second set based on the gradient intensity value corresponding to the at least one reference intra prediction mode; and if each gradient intensity value in the second set is zero, determining the reference intra prediction mode parameter based on a PLANAR mode; or if there is a non-zero gradient intensity value in the second set, determining a largest gradient intensity value from the second set, and determining the reference intra prediction mode parameter based on an intra prediction mode corresponding to the largest gradient intensity value.

It should be noted that, after the reference intra prediction mode parameter is determined based on the intra prediction mode corresponding to the largest gradient intensity value, the method may further include: assigning −1 to the largest gradient intensity value in the second set, to determine a third set; and if the intra prediction mode corresponding to the largest gradient intensity value is the same as a first color component prediction mode of a first color component block co-located with the reference block, determining a new largest gradient intensity value from the third set, and determining the reference intra prediction mode parameter based on an intra prediction mode corresponding to the new largest gradient intensity value.

It should be further noted that, after the reference intra prediction mode parameter is determined based on the intra prediction mode corresponding to the new largest gradient intensity value, the method may further include: if the intra prediction mode corresponding to the new largest gradient intensity value is the same as the first color component prediction mode of the first color component block co-located with the reference block, determining the reference intra prediction mode parameter based on a DC mode.

In S1730, a predicted value of a second color component of the current block is determined based on the reference intra prediction mode parameter.

It should be noted that, in embodiments of this application, the process of determining the predicted value of the second color component of the current block based on the reference intra prediction mode parameter may include: constructing a candidate mode list for the second color component of the current block based on the reference intra prediction mode parameter; and determining the predicted value of the second color component of the current block based on the candidate mode list.

In some embodiments, the process of determining the reference block of the current block may include: determining at least one target sample adjacent to the current block; determining at least one first target block based on a block in which the at least one target sample is located; and determining the reference block of the current block based on the at least one first target block.

It should be noted that, in embodiments of this application, for the first target block, the method may further include: determining a reference intra prediction mode parameter of the at least one first target block by sequentially using the at least one first target block as the reference block in a first preset order; and constructing the candidate mode list for the second color component of the current block based on the reference intra prediction mode parameter of the at least one first target block.

It should be understood that the first preset order may be set manually or according to a specific rule in a specific scenario, which is not limited in embodiments of this application.

In some embodiments, the process of determining the reference block of the current block may further include: determining a first color component region co-located with the current block; and determining, from a plurality of blocks obtained by dividing the first color component region, at least one second target block at a preset position; and determining the reference block of the current block based on the at least one second target block.

It should be noted that, in embodiments of this application, for the second target block, the method may further include: sequentially determining a first color component prediction mode parameter of the at least one second target block in a preset order of the at least one second target block; and constructing the candidate mode list for the second color component of the current block based on the reference intra prediction mode parameter of the at least one first target block and the first color component prediction mode parameter of the at least one second target block.

Further, after the candidate mode list is determined, in some embodiments, the method may further include: determining first two prediction modes in the candidate mode list; performing an offset operation on mode index numbers of the first two prediction modes to determine at least one new intra prediction mode; and adding the at least one new intra prediction mode into the candidate mode list.

Further, after the candidate mode list is determined, in some embodiments, the method may further include: adjusting an order of prediction modes in the candidate mode list.

Further, in some embodiments, the process of determining the predicted value of the second color component of the current block based on the candidate mode list may include: determining a target prediction mode of the second color component of the current block based on the candidate mode list; and performing prediction on the second color component of the current block using the target prediction mode, to determine the predicted value of the second color component of the current block.

In a specific embodiment, the process of determining the target prediction mode of the second color component of the current block based on the candidate mode list may include: precoding the second color component of the current block based on at least one candidate prediction mode in the candidate mode list, to determine a precoding result of the at least one candidate prediction mode; determining a rate distortion cost value of the at least one candidate prediction mode based on the precoding result of the at least one candidate prediction mode; and determining a minimal rate distortion cost value from the rate distortion cost value of the at least one candidate prediction mode, and determining a candidate prediction mode corresponding to the minimal rate distortion cost value as the target prediction mode of the second color component of the current block.

In embodiments of this application, for at least one candidate prediction mode in the candidate mode list, a distortion value of the at least one candidate prediction mode can be determined. In a specific embodiment, the distortion value of the at least one candidate prediction mode may be determined based on a cost result of rate distortion optimization (RDO), or based on a cost result of a sum of absolute differences (SAD), or even based on a cost result of a sum of absolute transformed differences (SATD). No limitation is imposed herein.

For example, the rate distortion cost value is used as an example. The rate distortion cost value of the at least one candidate prediction mode may be determined based on the pre-encoding result of the at least one candidate prediction mode; then the smallest rate distortion cost value is selected therefrom, and the candidate prediction mode corresponding to the smallest rate distortion cost value is determined as the target prediction mode (that is, an optimal prediction mode), so that encoding efficiency of the second color component can be improved.

In some embodiments, the method may further include: determining, based on the candidate mode list, a mode index number corresponding to the target prediction mode; and encoding the mode index number to obtain encoded bits, and writing the encoded bits into a bitstream.

For example, referring to Table 4, binarization is performed using truncated unary code, where each mode index number may be encoded either using a context model or through bypass encoding.

TABLE 4

| Mode index number | Encoded bits |
|---|---|
| 0 | 0 |
| 1 | 10 |
| 2 | 110 |
| 3 | 1110 |
| . . . | . . . |
| Total number of target | 111111 . . . 1110 |
| prediction modes - 2 | (Total number of target prediction modes - |
| | 2 ones, 1 zero) |
| Total number of target | 111111 . . . 1111 |
| prediction modes - 1 | (Total number of target prediction modes - |
| | 1 ones) |

In S1740, a predicted difference value of the second color component of the current block is determined based on the predicted value of the second color component of the current block.

It should be noted that the process of determining the predicted difference value of the second color component of the current block based on the predicted value of the second color component of the current block may include: determining the predicted difference value of the second color component of the current block based on an original value of the second color component of the current block and the predicted value of the second color component of the current block.

Further, in some embodiments, the method may further include: encoding the predicted difference value of the second color component of the current block to obtain encoded bits, and writing the encoded bits into a bitstream.

In embodiments of this application, after the predicted value of the second color component of the current block is determined, a subtraction operation can be performed on the original value of the second color component of the current block and the predicted value of the second color component of the current block, to obtain the predicted difference value of the second color component of the current block. Then the predicted difference value is written into a bitstream.

It should be further noted that an embodiment of this application further provides a bitstream. The bitstream is generated by performing bit encoding on to-be-encoded information, and the to-be-encoded information may include at least one of following: a predicted difference value of a second color component of a current block, a mode index number, or a first parameter.

In embodiments of this application, after determining the predicted difference value of the second color component of the current block, the mode index number, and the first parameter, an encoding side can encode these pieces of information, write encoded information into the bitstream, and transmit the encoded information to a decoding side through the bitstream. In this way, subsequently, on the decoding side, information such as the predicted difference value of the second color component of the current block, the mode index number, and the first parameter can be directly determined by decoding the bitstream, thereby improving decoding efficiency.

An embodiment of this application provides an encoding method. A reference intra prediction mode parameter of a non-CCLM mode is determined with reference to a prediction mode of an adjacent encoded chroma block. In this way, not only completeness and diversity of chroma intra prediction modes can be improved, but also accuracy of chroma intra prediction can be improved, thereby improving encoding efficiency and thus improving encoding performance.

In still another embodiment of this application, when a chroma prediction mode of the adjacent encoded block is a CCLM mode, the adjacent encoded block still has its own texture content characteristics and spatial correlation with a current block, and both reconstructed luma information and reconstructed chroma information of the adjacent encoded block are encoded reconstructed information. Therefore, this embodiment of this application proposes a technology for deriving an LM model (Linear Model-Derived Mode, LM-DM) using the reconstructed information. Herein, for better chroma prediction, a plurality of prediction modes can be added through a derivation process to improve completeness of existing available chroma prediction modes.

For example, original five non-CCLM modes are replaced with MaxChromaCandidateListNum chroma prediction modes. The MaxChromaCandidateListNum chroma prediction modes may be sequentially added in a preset order, and thus mutual differences of the chroma prediction modes are ensured. MaxChromaCandidateListNum represents a preset quantity, indicating a maximum quantity of modes that can be stored in this chroma candidate list. For example, a chroma candidate list with a length of MaxChromaCandidateListNum may be first established, and then all modes may be sequentially added to the chroma candidate list in the preset order.

In addition, the chroma candidate list may be adjusted after being constructed (including adjustments in order and mode). There are three specific cases:
(1) If the chroma candidate list is constructed in the preset order and is unnecessary to be adjusted after being constructed, an encoding side needs to construct the chroma candidate list, and a decoding side only needs to construct a mode of a chroma candidate list index transmitted in a bitstream.
(2) If the chroma candidate list is constructed in the preset order and needs to be adjusted after being constructed, an encoding side and a decoding side each need to construct a complete chroma candidate list; and after the chroma candidate list is adjusted, the decoding side selects a mode corresponding to a chroma candidate list index transmitted in a bitstream.
(3) For the encoding side in (1), rate distortion optimization is required to performed on a constructed complete chroma candidate list. There may be a fast algorithm, including but not limited to performing rate distortion optimization only on first several modes. In this case, the encoding side us unnecessary to construct a chroma candidate list of all modes.

In a specific embodiment, the decoding side is used as an example. MaxChromaCandidateListNum chroma prediction modes may be sequentially added in the following preset order.

It should be understood that the following preset order is for exemplary purposes only, and the preset order for adding chroma prediction modes includes but is not limited to the order described below.
(1) According to positions shown in FIG. 3, luma intra prediction modes of CUs in which C, TL, TR, BL, and BR of a co-located luma block (an entire region filled with diagonal lines in the left figure) corresponding to a current chroma decoding block (an entire region filled with diagonal lines in the right figure) are located are sequentially added to the chroma candidate list in an order.

A derivation process for specific positions of C, TL, TR, BL, and BR are as follows:

It is assumed that a position of a corresponding co-located luma block at an upper-left corner of the current chroma decoding block relative to a luma block in an upper-left corner of an image (that is, a position of luma block TL) is (xCb, yCb), for the co-located luma block corresponding to the current chroma decoding block (the entire region filled with diagonal lines in the left figure), a width is cbWidth, and a height is cbHeight.

Coordinates of block C are (xCb+cbWidth/2, yCb+cbHeight/2).

Coordinates of block TL are (xCb, yCb).

Coordinates of block TR are (xCb+cbWidth−1, yCb).

Coordinates of block BL are (xCb, yCb+cbHeight−1).

Coordinates of block BR are (xCb+cbWidth−1, yCb+cbHeight−1).

A specific derivation rule for a luma prediction mode of the co-located luma block is as follows:
If a partition tree type is a single-tree type, referring to FIG. 4, a luma prediction mode of a CU in which C is located may be added to the chroma candidate list.

If the partition tree type is a dual-tree type, referring to FIG. 3, the following operations are performed:
Deriving a luma prediction mode of block C is used as an example. It is assumed that a position of a corresponding co-located luma block at an upper-left corner of the current chroma decoding block relative to a luma block in an upper-left corner of an image (that is, a position of luma block TL) is (xCb, yCb), for the co-located luma block corresponding to the current chroma decoding block (the entire region filled with diagonal lines in the left figure), a width is cbWidth, and a height is cbHeight. A derivation process of a luma prediction mode lumaIntraPredMode of block C is as follows:

First, whether block C in FIG. 3 uses a MIP mode is determined, where position information of block C is (xCb+cbWidth/2, yCb+cbHeight/2).

If IntraMipFlag[xCb+cbWidth/2][yCb+cbHeight/2] is 1, lumaIntraPredMode is set to INTRA PLANAR.

The array IntraMipFlag[x][y] indicates whether a decoding block including coordinates (x, y) uses the MIP mode.

Second, if CuPredMode[0][xCb+cbWidth/2][yCb+cbHeight/2] is MODE_IBC or MODE_PLT, lumaIntraPredMode is set to INTRA DC.

The array CuPredMode[chType][x][y] represents an intra prediction mode used by a luma or chroma decoding block including the coordinates (x, y), and chType being 0 indicates luma or chType being 1 indicates chroma.

Otherwise:
lumaIntraPredMode=IntraPredModeY[xCb+cbWidth/2][yCb+cbHeight/2].

The array IntraPredModeY[x][y] indicates an intra prediction mode used by a decoding block including the coordinates (x, y).

In some embodiments, referring to Table 2, a specific derivation rule for converting the luma prediction mode of the co-located luma block into a chroma prediction mode is as follows:
When sps_chroma_format_idc is 0, the chroma intra prediction mode is unnecessary to be used, and therefore this derivation rule does not exist.

When sps_chroma_format_idc is 2, mode X of the luma intra prediction mode lumaIntraPredMode specified in Table 3 is used to derive mode Y of a chroma intra prediction mode.

Otherwise, the chroma intra prediction mode is the same as the luma intra prediction mode luma IntraPredMode.
(2) According to positions shown in FIG. 5, chroma intra prediction modes of decoded chroma blocks in which chroma samples 0, 1, 2, 3, and 4 adjacent to the current chroma decoding block are located are sequentially added in an order.

A detailed position derivation process of the adjacent chroma samples 0, 1, 2, 3, and 4 is explained below:

It is assumed that a position of a chroma sample at an upper-left corner of the current chroma decoding block relative to a chroma sample at upper-left corner of an image is (xCb, yCb), a width of the current chroma decoding block is cbWidth, and a height of the current chroma decoding block is cbHeight.

Position information of chroma sample 0 is (xCb−1, yCb+cbHeight−1).

Position information of chroma sample 1 is (xCb+cbWidth−1, yCb−1).

Position information of chroma sample 2 is (xCb−1, yCb+cbHeight).

Position information of chroma sample 3 is (xCb+cbWidth, yCb−1).

Position information of the chroma sample 4 is (xCb−1, yCb−1).

In some embodiments, a specific rule for converting a chroma prediction mode of an adjacent decoded chroma block into a conventional chroma prediction mode is as follows:
when the prediction mode of the adjacent decoded chroma block is an inter mode, no adding operation is performed;
when the chroma prediction mode of the adjacent decoded chroma block is a CCLM mode, an LM-derived mode (Linear Model-derived Mode, LM-DM) process is performed; or
otherwise, the chroma intra prediction mode of the adjacent decoded chroma block is directly added.
(3) Modes of which mode indexes are obtained by adding mode indexes of first two modes among modes added in steps (1) and (2) with +1 or −1 are added. There are two manners herein: in manner 1, determining whether the mode is an angular mode; and if the mode is the angular mode, adding an angular mode obtained by offsetting an angle mapped by the angular mode clockwise or counterclockwise by a minimum angle unit, or if the mode is not the angular mode, performing no operation; and in manner 2, directly adding a corresponding mode index value with +1 or −1: if the mode index value is 0, adding only a mode with a mode index of 1, or if the mode index value is a maximum mode index, adding a mode with a mode index of the maximum mode index minus 1. If only one mode exists, only two angular modes obtained by offsetting the mode are added. If the mode is not the angular mode, step (3) is not performed.
(4) A preset default non-CCLM mode chroma candidate list is added (the default chroma candidate list includes but is not limited to a subsequently described form). Modes in the chroma candidate list are PLANAR_IDX, VER_IDX, HOR_IDX, DC_IDX, VDIA_IDX, VER_IDX−4, VER_IDX+4, HOR_IDX−4, and HOR_IDX+4, respectively.

In embodiments of this application, when the chroma prediction mode of the adjacent decoded chroma block is a CCLM mode, an LM-DM derivation process is performed. The derivation process mainly includes the following three steps: in step 1, determining a template region and obtaining reconstructed samples of the template region; in step 2, calculating a gradient of the samples obtained in step 1, mapping the calculated gradient into an angular mode and recording the angular mode in a histogram; and in step 3, deriving the LM-DM mode.

It is assumed that coordinates of a position of a chroma sample at an upper-left corner of the adjacent decoded chroma block relative to a chroma sample at an upper-left corner of an image are (xCbNb, yCbNb), a width of a chroma sample is CbNbWidth, and a height of the chroma sample is CbNbHeight. That sps_chroma_format_idc is 1 is used as an example, that is, YUV420 format. Therefore, a width of a luma sample is 2×CbNbWidth, and a height of the luma sample is 2×CbNbHeight.

In step 1, a template region is determined and reconstructed samples (that is, an input) of the template region are obtained.

Input: A chroma sample in an adjacent region of the adjacent decoded chroma block is pC[x][y], where x∈[−3, CbNbWidth], y∈[−3, −1], x∈[−3, −1], y∈[0, CbNbHeight], and an origin [0][0] is coordinates of a chroma sample at an upper-left corner of the block. A co-located luma sample of the adjacent region of the adjacent decoded chroma block is pY[x][y], where x∈[−3, 2×CbNbWidth], y∈[−3, −1], x∈[−3, −1], y∈[0, 2×CbNbHeight], and the origin [0][0] is luma sample coordinates corresponding to the chroma sample at the upper-left corner of the block. Specific positions are shown by dot samples in FIG. 10A and dot samples in FIG. 10B.

In step 2, gradient of the samples obtained in step 1 is calculated, the calculated gradient is mapped into an angular mode and the angular mode is recorded in a histogram. For specific pseudocode, one may refer to the content described above.

One of implementations is used as an example. Gradient intensity values iAmp in steps (1) and (2) are accumulated based on a corresponding intra prediction mode ipm, and a histogram HOG is established with the intra prediction mode ipm as a horizontal coordinate and a gradient intensity value iAmp as a vertical coordinate, as shown in FIG. 14.

In step 3, the LM-DM mode (that is, an output) is derived.

Output: The chroma intra prediction mode IntraPredModeD may be derived from LM-DM, and a mode index range is [0, 66].

If there is no non-zero gradient intensity value in the histogram HOG, IntraPredModeD=INTRA PLANAR.

Otherwise, IntraPredModeD is set to argmax i(HoG[i]), and HoG[IntraPredModeD] is set to −1.

If IntraPredModeD is the same as a DM mode of a chroma block in which (xCbNb, yCbNb) is located, searching is performed again, and IntraPredModeD is set to argmax i (HoG[i]).

If IntraPredModeD is still the same as the DM mode of the chroma block in which (xCbNb, yCbNb) is located, IntraPredModeD is set to INTRA DC.

In some embodiments, for an adjacent decoded block, template samples in its adjacent region are still used for analysis. However, because luma samples and chroma samples inside the block have been reconstructed, all internal samples of the adjacent decoded block may also be used to derive the LM-DM mode in embodiments of this application.

Detailed steps of the LM-DM derivation process are as follows:
It is assumed that coordinates of a position of a sample at an upper-left corner of the adjacent decoded chroma block relative to a sample at an upper-left corner of an image are (xCbNb, yCbNb), a width of a chroma sample is CbNbWidth, and a height of the chroma sample is CbNbHeight. That sps_chroma_format_idc is 1 is used as an example, that is, YUV420 format. Therefore, a width of a luma sample is 2×CbNbWidth, and a height of the luma sample is 2×CbNbHeight.

In step 1: a template region is determined and reconstructed samples (that is, an input) of the template region are obtained.

Input: A chroma sample of the adjacent decoded chroma block is pC[x][y], where x∈[0, CbNbWidth−1], y∈[0, CbNbHeight−1], and an origin [0][0] is coordinates of a chroma sample at an upper-left corner of the block. A co-located luma sample of the adjacent decoded chroma block is pY[x][y], where x∈[0, 2×CbNbWidth−1], y∈[0, 2×CbNbHeight−1],and the origin [0][0] is luma sample coordinates corresponding to the chroma sample at the upper-left corner of the block. Specific positions are shown by dot samples in FIG. 11A and dot samples in FIG. 11B.

In step 2, gradient of the samples obtained in step 1 is calculated, the calculated gradient is mapped into an angular mode and the angular mode is recorded in a histogram. For specific pseudocode, one may refer to the content described above. Details are not described herein again.

In step 3, the LM-DM mode (that is, an output) is derived.

Output: The chroma intra prediction mode IntraPredModeD may be derived from LM-DM, and a mode index range is [0, 66].

If there is no non-zero gradient intensity value in the histogram HOG, IntraPredModeD=INTRA PLANAR.

Otherwise, IntraPredModeD is set to argmax i(HoG[i]), and HoG [IntraPredModeD] is set to −1.

If IntraPredModeD is the same as a DM mode of a chroma block in which (xCbNb, yCbNb) is located, searching is performed again, and IntraPredModeD is set to argmax i (HoG[i]).

If IntraPredModeD is still the same as the DM mode of the chroma block in which (xCbNb, yCbNb) is located, IntraPredModeD is set to INTRA_DC.

In some other embodiments, when all internal samples of the adjacent decoded block are used to derive the LM-DM mode, computational complexity increases as a quantity of luma samples and chroma samples inside the block increases. Therefore, in order to reduce complexity, alternatively, a part of internal samples of the adjacent decoded block may be used for analysis.

Herein, description is given by using an example in which adjacent chroma samples are located at chroma sample 0 and chroma sample 1 in FIG. 5.
(i) The adjacent chroma sample is located, for example, at chroma sample 0 in FIG. 5, and detailed steps of the LM-DM derivation process are as follows:

In step 1, a template region is determined and reconstructed samples (that is, an input) of the template region are obtained.

Input: A chroma sample of the adjacent decoded chroma block is pC[x][y], where x∈[CbNbWidth−3, CbNbWidth−1], y∈[0, CbNbHeight−1], and an origin [0][0] is coordinates of a chroma sample at an upper-left corner of the block. A co-located luma sample of the adjacent decoded chroma block is pY[x][y], where x∈[2×CbNbWidth−3, 2×CbNbWidth−1], y∈[0, 2×CbNbHeight−1], and the origin [0][0] is luma sample coordinates corresponding to the chroma sample at the upper-left corner of the block. Specific positions are shown by dot samples in FIG. 12A and dot samples in FIG. 12B.

In step 2, gradient of the samples obtained in step 1 is calculated, the calculated gradient is mapped into an angular mode and the angular mode is recorded in a histogram. For specific pseudocode, one may refer to the foregoing description. Details are not described herein again.

In step 3, the LM-DM mode (that is, an output) is derived.
(ii) The adjacent chroma sample is located, for example, at chroma sample 1 in FIG. 5, and detailed steps of the LM-DM derivation process are as follows:

In step 1, a template region is determined and reconstructed samples (that is, an input) of the template region are obtained.

Input: A chroma sample of the adjacent decoded chroma block is pC[x][y], where x∈[0, CbNbWidth−1], y∈[CbNbHeight−3, CbNbHeight−1], and an origin [0][0] is coordinates of a chroma sample at an upper-left corner of the block. A co-located luma sample of the adjacent decoded chroma block is pY[x][y], where x∈[0,2×CbNbWidth−1], y∈[2×CbNbHeight−3, 2×CbNbHeight−1], and the origin [0][0] is luma sample coordinates corresponding to the chroma sample at the upper-left corner of the block. Specific positions are shown by dot samples in FIG. 13A and dot samples in FIG. 13B.

In step, gradient of the samples obtained in step 1 is calculated, the calculated gradient is mapped into an angular mode and the angular mode is recorded in a histogram. For specific pseudocode, one may refer to the content described above. Details are not described herein again.

In step 3, the LM-DM mode (that is, an output) is derived.

Output: The chroma intra prediction mode IntraPredModeD may be derived from LM-DM, and a mode index range is [0, 66].

If there is no non-zero gradient intensity value in the histogram HOG, IntraPredModeD is set to INTRA_PLANAR.

Otherwise, IntraPredModeD is set to argmax i(HoG[i]), and HoG [IntraPredModeD] is set to −1.

If IntraPredModeD is the same as a DM mode of a chroma block in which (xCbNb, yCbNb) is located, searching is performed again, and IntraPredModeD is set to argmax i (HoG[i]).

If IntraPredModeD is still the same as the DM mode of the chroma block in which (xCbNb, yCbNb) is located, IntraPredModeD is set to INTRA_DC.

In short, in embodiments of this application, when a chroma prediction mode of an adjacent encoded/decoded chroma block is a CCLM mode, the adjacent encoded/decoded chroma block still has its own texture content characteristics and spatial correlation with a current encoded/decoded block, and both reconstructed luma information and reconstructed chroma information of the adjacent encoded/decoded block are encoded/decoded reconstructed information. Therefore, the foregoing reconstructed information is used for deriving the LM-DM mode in embodiments of this application.

It should be further noted that, in embodiments of this application, a method for deriving a non-CCLM mode of a chroma intra block of the LM-DM mode may include:
(1) performing texture gradient analysis by fully utilizing content characteristics of the encoded/decoded block; and
(2) deriving the non-CCLM mode through luma and chroma by fully utilizing high correlation between luma and chroma.

In this embodiment of this application, specific implementation of the foregoing embodiments is described in detail through the examples described above. According to the technical solutions of the foregoing embodiments, completeness of chroma intra prediction modes can be improved according to embodiments of this application. Texture gradient analysis is performed on adjacent encoded/decoded chroma and luma blocks, a gradient histogram corresponding to a plurality of angular modes is constructed, and horizontal and vertical intensities of the template region are calculated respectively by using horizontal and vertical Sobel filters, an angular mode is determined, and an amplitude is updated, to obtain an optimal non-CCLM mode. In a case that the current encoding/decoding block has different content characteristics, diversity of chroma intra prediction modes can be further improved according to embodiments of this application, thereby obtaining a more accurate chroma prediction value.

In still another embodiment of this application, reference is made to FIG. 18, which is a schematic diagram of a structure of an encoder according to an embodiment of this application. As shown in FIG. 18, the encoder 1800 may include: a first determining unit 1810 and a first prediction unit 1820.

The first determining unit 1810 is configured to: determine a reference block of a current block, where the reference block is an adjacent block of the current block; and when a prediction mode of a second color component of the reference block satisfies a first condition, determine a reference intra prediction mode parameter based on the reference block.

The first prediction unit 1820 is configured to determine a predicted value of a second color component of the current block based on the reference intra prediction mode parameter.

The first determining unit 1810 is further configured to determine a predicted difference value of the second color component of the current block based on the predicted value of the second color component of the current block.

In some embodiments, the first condition includes: the prediction mode of the second color component of the reference block is a first preset mode.

In some embodiments, the first preset mode includes at least one of the following: an inter-component prediction mode, an IBC mode, a MIP mode, or a palette mode.

In some embodiments, the inter-component prediction mode is a CCLM mode.

In some embodiments, the first preset mode is an inter prediction mode.

In some embodiments, the first condition includes: the prediction mode of the second

color component of the reference block is not a second preset mode.

In some embodiments, the second preset mode is an angular prediction mode.

In some embodiments, the second preset mode is a DC mode or a planar mode.

In some embodiments, the first condition includes: a first parameter is determined, where the first parameter indicates to determine the reference intra prediction mode parameter based on the reference block.

In some embodiments, referring to FIG. 18, the encoder 1800 may further include an encoding unit 1830, configured to encode the first parameter to obtain encoded bits, and write the encoded bits into a bitstream.

In some embodiments, referring to FIG. 18, the encoder 1800 may further include a first construction unit 1840.

The first construction unit 1840 is configured to construct a candidate mode list for the second color component of the current block based on the reference intra prediction mode parameter.

The first prediction unit 1820 is further configured to determine the predicted value of the second color component of the current block based on the candidate mode list.

In some embodiments, the first determining unit 1810 is further configured to: determine a reference sample based on the reference block; determine a first parameter based on a reconstructed sample value of the reference sample; and determine the reference intra prediction mode parameter based on the first parameter.

In some embodiments, the first determining unit 1810 is further configured to determine the reference sample based on a sample in an adjacent region of the reference block, where the adjacent region includes at least one of the following: a left adjacent region, an upper adjacent region, or an upper-left adjacent region.

In some embodiments, the first determining unit 1810 is further configured to determine the reference sample based on a sample in the reference block.

In some embodiments, the first determining unit 1810 is further configured to: calculate a gradient of the reconstructed sample value of the reference sample to determine a horizontal gradient value and a vertical gradient value of the reference sample; perform angle mapping based on the horizontal gradient value and the vertical gradient value of the reference sample to determine at least one intra prediction mode corresponding to the reference sample; calculate gradient intensity based on the horizontal gradient value and the vertical gradient value of the reference sample to determine at least one gradient intensity value corresponding to the reference sample; and determine the first parameter based on the at least one intra prediction mode and the at least one gradient intensity value corresponding to the reference sample.

In some embodiments, the reference sample includes at least one candidate sample, and each candidate sample corresponds to an intra prediction mode and a gradient intensity value; and the first determining unit 1810 is further configured to: determine a horizontal gradient absolute value and a vertical gradient absolute value of the candidate sample; perform angle mapping based on the horizontal gradient absolute value and the vertical gradient absolute value of the candidate sample to determine an initial mode index value of the candidate sample; and determine, based on the initial mode index value of the candidate sample, an intra prediction mode corresponding to the candidate sample.

In some embodiments, the first determining unit 1810 is further configured to compensate the initial mode index value by using a preset angle compensation value to determine a target mode index value of the candidate sample; and determine, based on the target mode index value of the candidate sample, an intra prediction mode corresponding to the candidate sample.

In some embodiments, the first determining unit 1810 is further configured to: determine a target quadrant value of the candidate sample; determine a value corresponding to the target quadrant value according to a preset mapping relationship; and set the preset angle compensation value to be equal to the value.

In some embodiments, the first determining unit 1810 is further configured to: determine a first symbol value based on a horizontal gradient value of the candidate sample; determine a second symbol value based on a vertical gradient value of the candidate sample; determine a comparison value of the candidate sample based on a comparison result of the horizontal gradient absolute value and the vertical gradient absolute value of the candidate sample; and perform quadrant mapping based on the comparison value, the first symbol value, and the second symbol value to determine the target quadrant value corresponding to the candidate sample.

In some embodiments, the first determining unit 1810 is further configured to calculate a sum of the horizontal gradient absolute value and the vertical gradient absolute value of the candidate sample to determine a gradient intensity value corresponding to the candidate sample.

In some embodiments, the reconstructed sample value of the reference sample includes at least one of the following: a reconstructed sample value of a first color component of the reference sample; or a reconstructed sample value of a second color component of the reference sample.

In some embodiments, the first determining unit 1810 is further configured to: when the reconstructed sample value of the reference sample is the reconstructed sample value of the first color component of the reference sample, determine at least one intra prediction mode and at least one gradient intensity value corresponding to the first color component of the reference sample; and when the reconstructed sample value of the reference sample is reconstructed sample value of the second color component of the reference sample, determine at least one intra prediction mode and at least one gradient intensity value corresponding to the second color component of the reference sample.

The first construction unit 1840 is further configured to form a first set based on the at least one intra prediction mode corresponding to the first color component of the reference sample and the at least one intra prediction mode corresponding to the second color component of the reference sample, where the first set includes at least one reference intra prediction mode with different characteristics.

The first determining unit 1810 is further configured to: accumulate, based on the at least one gradient intensity value corresponding to the first color component of the reference sample and the at least one gradient intensity value corresponding to the second color component of the reference sample, gradient intensity values belonging to a same reference intra prediction mode, to determine a gradient intensity value corresponding to the at least one reference intra prediction mode; and determine the first parameter based on the at least one reference intra prediction mode and the gradient intensity value corresponding to the at least one reference intra prediction mode.

In some embodiments, the first determining unit 1810 is further configured to: form a second set based on the gradient intensity value corresponding to the at least one reference intra prediction mode; and if each gradient intensity value in the second set is zero, determine the reference intra prediction mode parameter based on a PLANAR mode; or if there is a non-zero gradient intensity value in the second set, determine a largest gradient intensity value from the second set, and determining the reference intra prediction mode parameter based on an intra prediction mode corresponding to the largest gradient intensity value.

In some embodiments, the first determining unit 1810 is further configured to: assign −1 to the largest gradient intensity value in the second set, to determine a third set; and if the intra prediction mode corresponding to the largest gradient intensity value is the same as a first color component prediction mode of a first color component block co-located with the reference block, determine a new largest gradient intensity value from the third set, and determine the reference intra prediction mode parameter based on an intra prediction mode corresponding to the new largest gradient intensity value.

In some embodiments, the first determining unit 1810 is further configured to: if the intra prediction mode corresponding to the new largest gradient intensity value is the same as the first color component prediction mode of the first color component block co-located with the reference block, determine the reference intra prediction mode parameter based on a DC mode. In some embodiments, the first determining unit 1810 is further configured to:
determine at least one target sample adjacent to the current block; determine at least one first target block based on a block in which the at least one target sample is located; and determine the reference block of the current block based on the at least one first target block.

In some embodiments, the first determining unit 1810 is further configured to: determine a reference intra prediction mode parameter of the at least one first target block by sequentially using the at least one first target block as the reference block in a first preset order; and
the first construction unit 1840 is further configured to: construct the candidate mode list for the second color component of the current block based on the reference intra prediction mode parameter of the at least one first target block.

In some embodiments, the first determining unit 1810 is further configured to: determine a first color component region co-located with the current block; determine, from at least one block obtained by dividing the first color component region, at least one second target block at a preset position; and determine the reference block of the current block based on at least one second target block.

In some embodiments, the first determining unit 1810 is further configured to: sequentially determine a first color component prediction mode parameter of the at least one second target block in a preset order of the at least one second target block; and the first construction unit 1840 is further configured to: construct the candidate mode list for the second color component of the current block based on the reference intra prediction mode parameter of the at least one first target block and the first color component prediction mode parameter of the at least one second target block.

In some embodiments, the first determining unit 1810 is further configured to: determine first two prediction modes in the candidate mode list; perform an offset operation on mode index numbers of the first two prediction modes to determine at least one new intra prediction mode; and add the at least one new intra prediction mode into the candidate mode list.

In some embodiments, referring to FIG. 18, the encoder 1800 may further include a first adjustment unit 1850, configured to adjust an order of prediction modes in the candidate mode list.

In some embodiments, the first determining unit 1810 is further configured to: determine a target prediction mode of the second color component of the current block based on the candidate mode list; and the first prediction unit 1820 is further configured to: perform prediction on the second color component of the current block using the target prediction mode, to determine the predicted value of the second color component of the current block.

In some embodiments, the encoding unit 1830 is further configured to: precode the second color component of the current block based on at least one candidate prediction mode in the candidate mode list, to determine a precoding result of the at least one candidate prediction mode; and
the first determining unit 1810 is further configured to: determine a rate distortion cost value of the at least one candidate prediction mode based on the precoding result of the at least one candidate prediction mode; and determine a minimal rate distortion cost value from the rate distortion cost value of the at least one candidate prediction mode, and determine a candidate prediction mode corresponding to the minimal rate distortion cost value as the target prediction mode of the second color component of the current block.

In some embodiments, the first determining unit 1810 is further configured to: determine, based on the candidate mode list, a mode index number corresponding to the target prediction mode; and
the encoding unit 1830 is further configured to: encode mode index number to obtain encoded bits, and write the encoded bits into a bitstream.

In some embodiments, the first determining unit 1810 is further configured to: determine the predicted difference value of the second color component of the current block based on an original value of the second color component of the current block and the predicted value of the second color component of the current block; and
the encoding unit 1830 is further configured to: encode the predicted difference value of the second color component of the current block to obtain encoded bits, and write the encoded bits into a bitstream.

It may be understood that in embodiments of this application, the “unit” may be a partial circuit, a partial processor, a partial program or partial software, or the like, or certainly, may be a module, or may be non-modular. In addition, component parts in the embodiments may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in the form of a software functional module and not sold or used as an independent product, the integrated unit may be stored in a computer-readable storage medium. Based on such an understanding, the technical solutions of the embodiments essentially, or the part contributing to the conventional technology, or all or some of the technical solutions may be implemented in a form of a software product. The computer software product is stored in a storage medium and includes several instructions for instructing a computer device (which may be a personal computer, a server, a network device, or the like) or a processor to perform all or some of the steps of the methods described in the embodiments. The foregoing storage medium includes various media that may store a program code, such as a USB flash drive, a removable hard disk, a read-only memory (ROM), a random access memory (RAM), a magnetic disk, or an optical disc.

Therefore, an embodiment of this application provides a computer-readable storage medium, applied to an encoder 1800. The computer-readable storage medium stores a computer program, and the computer program is executed by a first processor to implement the method according to any one of the foregoing embodiments.

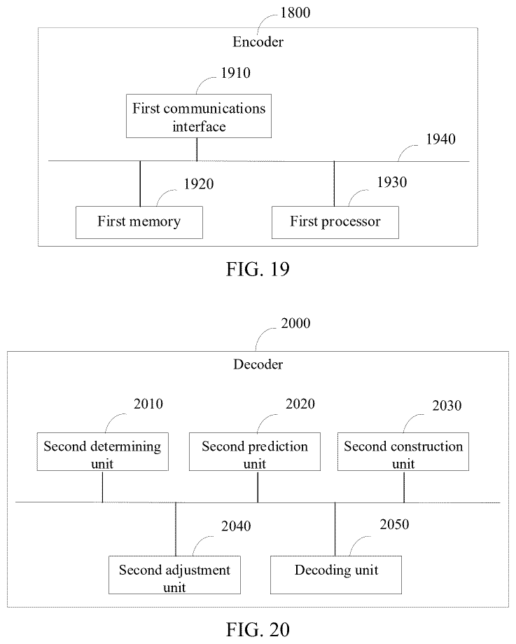

Based on the composition of the encoder 1800 and the computer-readable storage medium, reference is made to FIG. 19, which is a schematic diagram of a structure of specific hardware of the encoder 1800 according to an embodiment of this application. As shown in FIG. 19, the encoder 1800 may include a first communications interface 1910, a first memory 1920, and a first processor 1930. The components are coupled together by using a first bus system 1940. It may be understood that the first bus system 1940 is configured to implement connection and communication between these components. The first bus system 1940 may further include a power bus, a control bus, a status signal bus, and the like, in addition to a data bus. However, for clarity of description, various buses are marked as the first bus system 1940 in FIG. 19.

The first communications interface 1910 is configured to receive and transmit signals in the process of transmitting and receiving information with other external network elements.

The first memory 1920 is configured to store a computer program runnable on the first processor 1930.

The first processor 1930 is configured to run the computer program to perform the following operations:
determining a reference block of a current block, where the reference block is an adjacent block of the current block; when a prediction mode of a second color component of the reference block satisfies a first condition, determining a reference intra prediction mode parameter based on the reference block; and determining a predicted value of a second color component of the current block based on the reference intra prediction mode parameter; and determining a predicted difference value of the second color component of the current block based on the predicted value of the second color component of the current block.

It may be understood that, in embodiments of this application, the first memory 1920 may be a volatile memory or a non-volatile memory, or may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and is used as an external cache. By way of example rather than limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DRRAM). The first memory 1920 in the systems and the methods described in this application include but are not limited to these and any memory of another appropriate type.

However, the first processor 1930 may be an integrated circuit chip and has a signal processing capability. In an implementation process, steps in the foregoing method can be implemented by using a hardware integrated logic circuit in the first processor 1930, or by using instructions in a form of software. The first processor 1930 may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor may implement or execute the methods, steps, and logical block diagrams disclosed in embodiments of this application. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in the first memory 1920, and the first processor 1930 reads information in the first memory 1920 and completes the steps of the foregoing methods in combination with hardware of the first processor.

It may be understood that the embodiments described in this application can be implemented in hardware, software, firmware, middleware, microcode, or a combination thereof. For hardware implementation, the processing unit may be implemented in one or more application-specific integrated circuits (ASIC), digital signal processors (DSP), digital signal processing devices (DSP Device, DSPD), programmable logic devices (PLD), field programmable gate arrays (FPGA), general-purpose processors, controllers, microcontrollers, microprocessors, and other electronic units configured to perform the functions described in this application, or a combination thereof. For software implementation, the technologies described in this application may be implemented by modules (for example, processes and functions) that perform the functions described in this application. Software code may be stored in a memory and executed by a processor. The memory may be implemented in the processor or outside the processor.

Optionally, in another embodiment, the first processor 1930 is further configured to run the computer program to perform the method according to any one of the foregoing embodiments.

This embodiment provides an encoder. In the encoder, a related parameter for a reference block adjacent to a current block is analyzed, so that a reference intra prediction mode parameter of a non-CCLM mode can be determined. Based on the reference intra prediction mode parameter, completeness and diversity of chroma intra prediction modes can be improved, so that accuracy of chroma intra prediction can be improved, and further, encoding efficiency can be improved, thereby improving encoding performance.

In still another embodiment of this application, reference is made to FIG. 20, which is a schematic diagram of a structure of a decoder according to an embodiment of this application. As shown in FIG. 20, the decoder 2000 may include: a second determining unit 2010 and a second prediction unit 2020.

The second determining unit 2010 is configured to: determine a reference block of a current block, where the reference block is an adjacent block of the current block; and when a prediction mode of a second color component of the reference block satisfies a first condition, determine a reference intra prediction mode parameter based on the reference block.

The second prediction unit 2020 is configured to determine a predicted value of a second color component of the current block based on the reference intra prediction mode parameter.

In some embodiments, the first condition includes: the prediction mode of the second color component of the reference block is a first preset mode.

In some embodiments, the first preset mode includes at least one of the following: an inter-component prediction mode, an IBC mode, a MIP mode, or a palette mode.

In some embodiments, the inter-component prediction mode is a CCLM mode.

In some embodiments, the first preset mode is an inter prediction mode.

In some embodiments, the first condition includes: the prediction mode of the second color component of the reference block is not a second preset mode.

In some embodiments, the second preset mode is an angular prediction mode.

In some embodiments, the second preset mode is a DC mode or a planar mode.

In some embodiments, the first condition includes: a bitstream is determined, and a first parameter is determined, where the first parameter indicates to determine the reference intra prediction mode parameter based on the reference block.

In some embodiments, referring to FIG. 20, the decoder 2000 may further include a second construction unit 2030, where
the second construction unit 2030 is configured to construct a candidate mode list for the second color component of the current block based on the reference intra prediction mode parameter; and
the second prediction unit 2020 is further configured to determine the predicted value of the second color component of the current block based on the candidate mode list.

In some embodiments, the second determining unit 2010 is further configured to: determine a reference sample based on the reference block; determine a first parameter based on a reconstructed sample value of the reference sample; and determine the reference intra prediction mode parameter based on the first parameter.

In some embodiments, the second determining unit 2010 is further configured to determine the reference sample according to a sample in an adjacent region of the reference block, where the adjacent region includes at least one of the following: a left adjacent region, an upper adjacent region, or an upper-left adjacent region.

In some embodiments, the second determining unit 2010 is further configured to determine the reference sample based on a sample in the reference block.

In some embodiments, the second determining unit 2010 is further configured to: calculate a gradient of the reconstructed sample value of the reference sample to determine a horizontal gradient value and a vertical gradient value of the reference sample; perform angle mapping based on the horizontal gradient value and the vertical gradient value of the reference sample to determine at least one intra prediction mode corresponding to the reference sample; calculate gradient intensity based on the horizontal gradient value and the vertical gradient value of the reference sample to determine at least one gradient intensity value corresponding to the reference sample; and determine the first parameter based on the at least one intra prediction mode and the at least one gradient intensity value corresponding to the reference sample.

In some embodiments, the reference sample includes at least one candidate sample, and each candidate sample corresponds to an intra prediction mode and a gradient intensity value; and the second determining unit 2010 is further configured to: determine a horizontal gradient absolute value and a vertical gradient absolute value of the candidate sample; perform angle mapping based on the horizontal gradient absolute value and the vertical gradient absolute value of the candidate sample to determine an initial mode index value of the candidate sample; and determine, based on the initial mode index value of the candidate sample, an intra prediction mode corresponding to the candidate sample.

In some embodiments, the second determining unit 2010 is further configured to: compensate the initial mode index value by using a preset angle compensation value to determine a target mode index value of the candidate sample; and determine, based on the target mode index value of the candidate sample, an intra prediction mode corresponding to the candidate sample.

In some embodiments, the second determining unit 2010 is further configured to determine a target quadrant value of the candidate sample; determine a value corresponding to the target quadrant value according to a preset mapping relationship; and set the preset angle compensation value to be equal to the value.

In some embodiments, the second determining unit 2010 is further configured to: determine a first symbol value based on a horizontal gradient value of the candidate sample; determine a second symbol value based on a vertical gradient value of the candidate sample; determine a comparison value of the candidate sample based on a comparison result of the horizontal gradient absolute value and the vertical gradient absolute value of the candidate sample; and perform quadrant mapping based on the comparison value, the first symbol value, and the second symbol value to determine the target quadrant value corresponding to the candidate sample.

In some embodiments, the second determining unit 2010 is further configured to calculate a sum of the horizontal gradient absolute value and the vertical gradient absolute value of the candidate sample to determine a gradient intensity value corresponding to the candidate sample.

In some embodiments, the reconstructed sample value of the reference sample includes at least one of the following: a reconstructed sample value of a first color component of the reference sample; or a reconstructed sample value of a second color component of the reference sample.

In some embodiments, the second determining unit 2010 is further configured to: when the reconstructed sample value of the reference sample is the reconstructed sample value of the first color component of the reference sample, determine at least one intra prediction mode and at least one gradient intensity value corresponding to the first color component of the reference sample; or when the reconstructed sample value of the reference sample is the reconstructed sample value of the second color component of the reference sample, determine at least one intra prediction mode and at least one gradient intensity value corresponding to the second color component of the reference sample;
the second construction unit 2030 is further configured to: form a first set based on the at least one intra prediction mode corresponding to the first color component of the reference sample and the at least one intra prediction mode corresponding to the second color component of the reference sample, where the first set includes at least one reference intra prediction mode with different characteristics;
the second determining unit 2010 is further configured to: accumulate, based on the at least one gradient intensity value corresponding to the first color component of the reference sample and the at least one gradient intensity value corresponding to the second color component of the reference sample, gradient intensity values belonging to a same reference intra prediction mode, to determine a gradient intensity value corresponding to the at least one reference intra prediction mode; and
the second determining unit 2010 is further configured to: determine the first parameter based on the at least one reference intra prediction mode and the gradient intensity value corresponding to the at least one reference intra prediction mode.

In some embodiments, the second determining unit 2010 is further configured to: form a second set based on the gradient intensity value corresponding to the at least one reference intra prediction mode; and if each gradient intensity value in the second set is zero, determine the reference intra prediction mode parameter based on a PLANAR mode; or if there is a non-zero gradient intensity value in the second set, determine a largest gradient intensity value from the second set, and determine the reference intra prediction mode parameter based on an intra prediction mode corresponding to the largest gradient intensity value.

In some embodiments, the second determining unit 2010 is further configured to: assign −1 to the largest gradient intensity value in the second set, to determine a third set; and if the intra prediction mode corresponding to the largest gradient intensity value is the same as a first color component prediction mode of a first color component block co-located with the reference block, determine a new largest gradient intensity value from the third set, and determine the reference intra prediction mode parameter based on an intra prediction mode corresponding to the new largest gradient intensity value.

In some embodiments, the second determining unit 2010 is further configured to: if the intra prediction mode corresponding to the new largest gradient intensity value is the same as the first color component prediction mode of the first color component block co-located with the reference block, determine the reference intra prediction mode parameter based on a DC mode.

In some embodiments, the second determining unit 2010 is further configured to: determine at least one target sample adjacent to the current block; determine at least one first target block based on a block in which the at least one target sample is located; and determine the reference block of the current block based on the at least one first target block.

In some embodiments, the second determining unit 2010 is further configured to: determine a reference intra prediction mode parameter of the at least one first target block by sequentially using the at least one first target block as the reference block in a first preset order; and the construction unit 2030 is further configured to construct the candidate mode list for the second color component of the current block based on the reference intra prediction mode parameter of the at least one first target block.

In some embodiments, the second determining unit 2010 is further configured to: determine a first color component region co-located with the current block; determine, from at least one block obtained by dividing the first color component region, at least one second target block at a preset position; and determine the reference block of the current block based on the at least one second target block.

In some embodiments, the second determining unit 2010 is further configured to: sequentially determine a first color component prediction mode parameter of the at least one second target block in a preset order of the at least one second target block; and
the construction unit 2030 is further configured to construct the candidate mode list for the second color component of the current block based on the reference intra prediction mode parameter of the at least one first target block and the first color component prediction mode parameter of the at least one second target block.

In some embodiments, the second determining unit 2010 is further configured to: determine first two prediction modes in the candidate mode list; perform an offset operation on mode index numbers of the first two prediction modes to determine at least one new intra prediction mode; and add the at least one new intra prediction mode into the candidate mode list.

In some embodiments, referring to FIG. 20, the decoder 2000 may further include a second adjustment unit 2040, configured to adjust an order of prediction modes in the candidate mode list.

In some embodiments, referring to FIG. 20, the decoder 2000 may further include a decoding unit 2050, configured to parse a bitstream to determine a mode index number of the second color component of the current block;
the second determining unit 2010 is further configured to: determine, based on the candidate mode list, a target prediction mode corresponding to the mode index number; and
the second prediction unit 2020 is further configured to perform prediction on the second color component of the current block using the target prediction mode, to determine the predicted value of the second color component of the current block.

In some embodiments, the decoding unit 2050 is further configured to parse a bitstream to determine a predicted difference value of the second color component of the current block; and
the second determining unit 2010 is further configured to determine a reconstructed value of the second color component of the current block based on the predicted value of the second color component of the current block and the predicted difference value of the second color component of the current block.

It may be understood that in embodiments of this application, the “unit” may be a partial circuit, a partial processor, a partial program or partial software, or the like, or certainly, may be a module, or may be non-modular. In addition, component parts in the embodiments may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in the form of a software functional module and not sold or used as an independent product, the integrated unit may be stored in a computer-readable storage medium. Based on such an understanding, an embodiment of this application provides a computer-readable storage medium, applied to a decoder 2000. The computer-readable storage medium stores a computer program, and the computer program is executed by a second processor to implement the method according to any one of the foregoing embodiments.

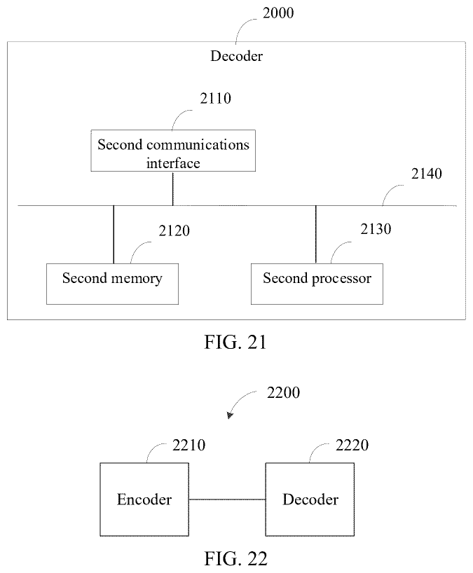

Based on the composition of the decoder 2000 and the computer-readable storage medium, reference is made to FIG. 21, which is a schematic diagram of a specific hardware structure of the decoder 2000 according to an embodiment of this application. As shown in FIG. 21, the decoder 2000 may include a second communications interface 2110, a second memory 2120, and a second processor 2130. The components are coupled together through a second bus system 2140. It may be understood that the second bus system 2140 is configured to implement connection and communication between these components. The second bus system 2140 may further include a power bus, a control bus, a status signal bus, and the like, in addition to a data bus. However, for clarity of description, various buses are marked as the second bus system 2140 in FIG. 21.

The second communications interface 2110 is configured to receive and transmit signals in the process of transmitting and receiving information with other external network elements.

The second memory 2120 is configured to store a computer program runnable on the second processor 2130.

The second processor 2130 is configured to run the computer program to perform the following operations:
determining a reference block of a current block, where the reference block is an adjacent block of the current block; when a prediction mode of a second color component of the reference block satisfies a first condition, determining a reference intra prediction mode parameter based on the reference block; and determining a predicted value of a second color component of the current block based on the reference intra prediction mode parameter.

Optionally, in another embodiment, the second processor 2130 is further configured to run the computer program to perform the method according to any one of the foregoing embodiments.

It may be understood that hardware functions of the second memory 2120 are similar to those of the first memory 1920, and hardware functions of the second processor 2130 are similar to those of the first processor 1930, which is not detailed herein.

This embodiment provides a decoder. In the decoder, a related parameter for a reference block adjacent to a current block is analyzed, so that a reference intra prediction mode parameter of a non-CCLM mode can be determined. Based on the reference intra prediction mode parameter, completeness and diversity of chroma intra prediction modes can be improved, so that accuracy of chroma intra prediction can be improved, and further, decoding efficiency can be improved, thereby improving decoding performance.

In still another embodiment of this application, reference is made to FIG. 22, which is a schematic structural diagram of a codec system according to an embodiment of this application. As shown in FIG. 22, the codec system 2200 may include an encoder 2210 and a decoder 2220.

In embodiments of this application, the encoder 2210 may be the encoder according to any one of the foregoing embodiments, and the decoder 2220 may be the decoder according to any one of the foregoing embodiments.

It should be noted that in this application, the terminology “include”, “comprise” or any other variant is intended to cover non-exclusive inclusion, so that a process, a method, an object or an apparatus that includes a series of elements not only includes those elements, but also includes other elements that are not explicitly listed, or includes inherent elements of the process, method, object or apparatus. In absence of more constraints, an element preceded by “includes a . . . ” does not preclude the existence of other identical elements in the process, method, article, or apparatus that includes the element.

The sequence numbers of the embodiments of this application are only for description, and do not represent superiority or inferiority of the embodiments.

The disclosed methods provided in the several method embodiments of this application may be randomly combined with each other in the case of no conflicts, to obtain new method embodiments.

The disclosed features provided in the several product embodiments of this application may be randomly combined with each other in the case of no conflicts, to obtain new product embodiments.

The disclosed features provided in the several method or device embodiments of this application may be randomly combined with each other in the case of no conflicts, to obtain new method embodiments or device embodiments.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

### INDUSTRIAL APPLICABILITY

In embodiments of this application, on a decoding side, a reference block of a current block is determined, where the reference block is an adjacent block of the current block; when a prediction mode of a second color component of the reference block satisfies a first condition, a reference intra prediction mode parameter is determined based on the reference block; and a prediction value of a second color component of the current block is determined based on the reference intra prediction mode parameter. On an encoding side, a reference block of the current block is determined, wherein the reference block is an adjacent block of the current block; when a prediction mode of a second color component of the reference block satisfies a first condition, a reference intra prediction mode parameter is determined based on the reference block; a predicted value of a second color component of the current block is determined based on the reference intra prediction mode parameter; and a predicted difference value of the second color component of the current block is determined based on the predicted value of the second color component of the current block. In this way, a related parameter for a reference block adjacent to a current block is analyzed, so that a reference intra prediction mode parameter of a non-CCLM mode can be determined. Based on the reference intra prediction mode parameter, completeness and diversity of chroma intra prediction modes can be improved, so that accuracy of chroma intra prediction can be improved, and further, encoding and decoding efficiency can be improved, thereby improving encoding and decoding performance.

What is claimed is:

1. A decoding method, applied to a decoder, wherein the method comprises:
determining a reference block of a current block, wherein the reference block is an adjacent block of the current block;
when a prediction mode of a second color component of the reference block satisfies a first condition, determining a reference intra prediction mode parameter based on the reference block; and
determining a predicted value of a second color component of the current block based on the reference intra prediction mode parameter.

2. The method according to claim 1, wherein the first condition comprises: the prediction mode of the second color component of the reference block is a first preset mode;
wherein the first preset mode comprises at least one of the following: an inter-component prediction mode, an IBC mode, a MIP mode, or a palette mode.

3. The method according to claim 1, wherein the first condition comprises: the prediction mode of the second color component of the reference block is not a second preset mode;
wherein the second preset mode is an angular prediction mode;
wherein the second preset mode is a DC mode or a planar mode.

4. The method according to claim 1, wherein the first condition comprises: a bitstream is decoded, and a first parameter is determined, wherein the first parameter indicates to determine the reference intra prediction mode parameter based on the reference block.

5. The method according to claim 1, wherein the determining the predicted value of the second color component of the current block based on the reference intra prediction mode parameter comprises:
constructing a candidate mode list for the second color component of the current block based on the reference intra prediction mode parameter; and
determining the predicted value of the second color component of the current block based on the candidate mode list.

6. The method according to claim 1, wherein the determining the reference intra prediction mode parameter based on the reference block comprises:
determining a reference sample based on the reference block;
determining a first parameter based on a reconstructed sample value of the reference sample; and
determining the reference intra prediction mode parameter based on the first parameter.

7. The method according to claim 6, wherein the determining the reference sample based on the reference block comprises:
determining the reference sample based on a sample in the reference block.

8. The method according to claim 6, wherein the determining the first parameter based on the reconstructed sample value of the reference sample comprises:
calculating a of the reconstructed sample value of the reference sample to determine a horizontal gradient value and a vertical gradient value of the reference sample;
performing angle mapping according to the horizontal gradient value and the vertical gradient value of the reference sample to determine at least one intra prediction mode corresponding to the reference sample;
calculating gradient intensity based on the horizontal gradient value and the vertical gradient value of the reference sample to determine at least one gradient intensity value corresponding to the reference sample; and
determining the first parameter based on the at least one intra prediction mode and the at least one gradient intensity value corresponding to the reference sample.

9. The method according to claim 5, wherein the determining the reference block of the current block comprises:
determining at least one target sample adjacent to the current block;
determining at least one first target block based on a block in which the at least one target sample is located; and
determining the reference block of the current block based on the at least one first target block;
wherein the method further comprises:
determining a reference intra prediction mode parameter of at least one the first target block by sequentially using the at least one first target block as the reference block in a first preset order; and
constructing the candidate mode list for the second color component of the current block based on the reference intra prediction mode parameter of the at least one first target block.

10. The method according to claim 9, wherein the determining the reference block of the current block further comprises:
determining a first color component region co-located with the current block;
determining, from at least one block obtained by dividing the first color component region, at least one second target block at a preset position; and
determining the reference block of the current block based on the at least one second target block;
wherein the method further comprises:
sequentially determining a first color component prediction mode parameter of the at least one second target block in a preset order of the at least one second target block; and
constructing the candidate mode list for the second color component of the current block based on the reference intra prediction mode parameter of the at least one first target block and the first color component prediction mode parameter of the at least one second target block.

11. The method according to claim 10, wherein the method further comprises:
adjusting an order of prediction modes in the candidate mode list.

12. An encoding method, applied to an encoder, wherein the method comprises:
determining a reference block of a current block, wherein the reference block is an adjacent block of the current block;
when a prediction mode of a second color component of the reference block satisfies a first condition, determining a reference intra prediction mode parameter based on the reference block;
determining a predicted value of a second color component of the current block based on the reference intra prediction mode parameter; and
determining a predicted difference value of the second color component of the current block based on the predicted value of the second color component of the current block.

13. The method according to claim 12, wherein the first condition comprises: the prediction mode of the second color component of the reference block is a first preset mode;
wherein the first preset mode comprises at least one of the following: an inter-component prediction mode, an IBC mode, a MIP mode, or a palette mode.

14. The method according to claim 12, wherein the first condition comprises: the prediction mode of the second color component of the reference block is not a second preset mode;
wherein the second preset mode is an angular prediction mode;
wherein the second preset mode is a DC mode or a planar mode.

15. The method according to claim 12, wherein the first condition comprises: a first parameter is determined and the first parameter indicates to determine the reference intra prediction mode parameter based on the reference block;
wherein the method further comprises:
encoding the first parameter to obtain encoded bits, and writing the encoded bits into a bitstream.

16. The method according to claim 12, wherein the determining the predicted value of the second color component of the current block based on the reference intra prediction mode parameter comprises:
constructing a candidate mode list for the second color component of the current block based on the reference intra prediction mode parameter; and
determining the predicted value of the second color component of the current block based on the candidate mode list.

17. The method according to claim 12, wherein the determining the reference intra prediction mode parameter based on the reference block comprises:
determining a reference sample based on the reference block;
determining a first parameter based on a reconstructed sample value of the reference sample; and
determining the reference intra prediction mode parameter based on the first parameter.

18. The method according to claim 17, wherein the determining the reference sample based on the reference block comprises:
determining the reference sample based on a sample in the reference block.

19. The method according to claim 16, wherein the determining the reference block of the current block comprises:
determining at least one target sample adjacent to the current block;
determining at least one first target block based on a block in which the at least one target sample is located; and
determining the reference block of the current block based on the at least one first target block;
wherein the method further comprises:
determining a reference intra prediction mode parameter of the at least one first target block by sequentially using the at least one first target block as the reference block in a first preset order; and
constructing the candidate mode list for the second color component of the current block based on the reference intra prediction mode parameter of the at least one first target block.

20. The method according to claim 19, wherein the method further comprises:
adjusting an order of prediction modes in the candidate mode list.
